(19) United States
(12) Patent Application Publication
(10) Pub. No.: US 2025/0181027 A1
(43) Pub. Date: Jun. 5, 2025

(54) IMAGE FORMING APPARATUS

(71) Applicant: CANON KABUSHIKI KAISHA, Tokyo (JP)

(72) Inventors: TOMOO AKIZUKI, Kanagawa (JP); HIROKI SASAME, Tokyo (JP); TAKAAKI AKAMATSU, Kanagawa (JP); YUKI IWAMOTO, Saitama (JP); AKITOSHI TOYOTA, Kanagawa (JP); YUTARO NOJI, Kanagawa (JP); RYOSUKE ODA, Hanoi (VN)

(21) Appl. No.: 18/948,341

(22) Filed: Nov. 14, 2024

(30) Foreign Application Priority Data
Nov. 30, 2023 (JP) 2023-203372

(51) Int. Cl. G03G 21/20; G03G 15/20; G03G 21/12

(52) U.S. Cl. CPC G03G 21/206; G03G 15/2017; G03G 21/12

(57) ABSTRACT

An image forming apparatus includes an image bearing member, a developing member, a transfer member, a cleaning member configured to remove toner from the surface of the image bearing member, a toner collecting container configured to collect the toner removed from the surface of the image bearing member by the cleaning member, a fixing unit configured to fix the toner image transferred onto the sheet by the transfer member to the sheet, and a duct disposed between the toner collecting container and the fixing unit, the duct forming an air passage through which air flowing toward an exterior of the image forming apparatus flows. The duct includes a first wall portion opposed to the fixing unit and a second wall portion opposed to the toner collecting container. The first wall portion is inclined with respect to the second wall portion.

### BACKGROUND OF THE INVENTION

### Field of the Invention

The present invention relates to image forming apparatuses for forming images on sheets.

### Description of the Related Art

Hitherto, an image forming apparatus based on an electrophotographic system and equipped with a process cartridge and a fixing device has been proposed (refer to Japanese Patent Application Laid-Open Publication No. H04-70680). The process cartridge is formed by assembling a photosensitive drum, a cleaner, a primary charging unit, and a developing unit in an integrated manner. A cross flow fan is arranged between the fixing device and the process cartridge, the cross flow fan sucking in air that has been warmed by the fixing device serving as a heat source and discharging the air toward the exterior of the image forming apparatus. A blade and a housing of the cross flow fan also function as a partition plate for shielding transfer of radiant heat from the fixing device.

However, the blade and the housing of the cross flow fan disclosed in Japanese Patent Application Laid-Open Publication No. H04-70680 leave room for enhancement regarding improvement of heat shielding performance.

### SUMMARY OF THE INVENTION

According to one aspect of the present invention, an image forming apparatus configured to form a toner image on a sheet, the image forming apparatus includes an image bearing member configured to rotate, a developing member configured to form a toner image on the image bearing member by supplying toner to the image bearing member, a transfer member configured to transfer the toner image formed on the image bearing member onto a sheet, a cleaning member configured to abut against a surface of the image bearing member and remove toner from the surface of the image bearing member, a toner collecting container configured to collect the toner removed from the surface of the image bearing member by the cleaning member, a fixing unit configured to fix the toner image transferred onto the sheet by the transfer member to the sheet, and a duct disposed between the toner collecting container and the fixing unit, the duct forming an air passage through which air flowing toward an exterior of the image forming apparatus flows. The duct includes a first wall portion opposed to the fixing unit and a second wall portion opposed to the toner collecting container. The first wall portion is inclined with respect to the second wall portion.

Further features of the present invention will become apparent from the following description of exemplary embodiments with reference to the attached drawings.

### BRIEF DESCRIPTION OF THE DRAWINGS

FIG. 1 is a schematic cross-sectional view of an image forming apparatus according to embodiment 1.

FIG. 2 is a front view of the image forming apparatus.

FIG. 3 is a perspective view of the image forming apparatus.

FIG. 4 is a left side view of the image forming apparatus.

FIG. 5 is a perspective view of a vicinity of a main body frame.

FIG. 6 is a schematic cross-sectional view of a vicinity of a heat exhaust duct.

FIG. 7A is a perspective view of the heat exhaust duct according to embodiment 1.

FIG. 7B is a front view of the heat exhaust duct.

FIG. 7C is a plan view of the heat exhaust duct.

FIG. 7D is a side view of the heat exhaust duct.

FIG. 8A is a perspective view of a heat exhaust duct according to comparative example 1.

FIG. 8B is a front view of the heat exhaust duct.

FIG. 8C is a plan view of the heat exhaust duct.

FIG. 8D is a side view of the heat exhaust duct.

FIG. 9A is a perspective view of a heat exhaust duct according to comparative example 2.

FIG. 9B is a front view of the heat exhaust duct.

FIG. 9C is a plan view of the heat exhaust duct.

FIG. 9D is a side view of the heat exhaust duct.

FIG. 10 is a schematic cross-sectional view illustrating a vicinity of a heat exhaust duct according to embodiment 2.

FIG. 11A is a perspective view of the heat exhaust duct according to embodiment 2.

FIG. 11B is a front view of the heat exhaust duct.

FIG. 11C is a plan view of the heat exhaust duct.

FIG. 11D is a side view of the heat exhaust duct.

FIG. 12 is a schematic cross-sectional view illustrating a vicinity of a heat exhaust valve according to embodiment 3.

FIG. 13A is a perspective view of the heat exhaust valve according to embodiment 3.

FIG. 13B is a front view of the heat exhaust duct.

FIG. 13C is a plan view of the heat exhaust duct.

FIG. 13D is a side view of the heat exhaust duct.

FIG. 14A is a perspective view illustrating a state in which a heat exhaust fin according to embodiment 3 is assembled to a main body portion of the heat exhaust duct.

FIG. 14B is a side view illustrating a state in which the heat exhaust fin is assembled to the main body portion of the heat exhaust duct.

FIG. 15 is a schematic cross-sectional view illustrating a vicinity of a heat exhaust duct according to embodiment 4.

FIG. 16A is a perspective view of the heat exhaust duct according to embodiment 4.

FIG. 16B is a front view of the heat exhaust duct.

FIG. 16C is a plan view of the heat exhaust duct.

FIG. 16D is a side view of the heat exhaust duct.

FIG. 17A is a perspective view of a heat exhaust duct according to embodiment 5.

FIG. 17B is a front view of the heat exhaust duct.

FIG. 17C is a plan view of the heat exhaust duct.

FIG. 17D is a side view of the heat exhaust duct.

FIG. 18A is a perspective view of a heat exhaust duct according to embodiment 6.

FIG. 18B is a front view of the heat exhaust duct.

FIG. 18C is a plan view of the heat exhaust duct.

FIG. 18D is a side view of the heat exhaust duct.

FIG. 19A is a perspective view of a heat exhaust duct according to embodiment 7.

FIG. 19B is a front view of the heat exhaust duct.

FIG. 19C is a plan view of the heat exhaust duct.

FIG. 19D is a side view of the heat exhaust duct.

FIG. 20A is a perspective view illustrating a state in which the heat exhaust fin according to embodiment 7 is assembled to a main body portion.

FIG. 20B is a side view illustrating a state in which the heat exhaust fin is assembled to the main body portion.

FIG. 21A is a perspective view of a heat exhaust duct according to embodiment 8.

FIG. 21B is a front view of the heat exhaust duct.

FIG. 21C is a plan view of the heat exhaust duct.

FIG. 21D is a side view of the heat exhaust duct.

FIG. 22A is a perspective view of a heat exhaust duct according to embodiment 9.

FIG. 22B is a front view of the heat exhaust duct.

FIG. 22C is a plan view of the heat exhaust duct.

FIG. 22D is a side view of the heat exhaust duct.

FIG. 23 is a schematic cross-sectional view illustrating a vicinity of a heat exhaust duct according to embodiment 10.

FIG. 24 is a schematic cross-sectional view illustrating a vicinity of a heat exhaust duct according to embodiment 11.

FIG. 25 is a schematic cross-sectional view of an image forming apparatus according to embodiment 12.

FIG. 26A is a perspective view of a heat exhaust duct according to embodiment 12.

FIG. 26B is a front view of the heat exhaust duct.

FIG. 26C is a plan view of the heat exhaust duct.

FIG. 26D is a side view of the heat exhaust duct.

FIG. 27 is a schematic cross-sectional view of an image forming apparatus according to embodiment 13.

FIG. 28A is a perspective view of a heat exhaust duct according to embodiment 13.

FIG. 28B is a front view of the heat exhaust duct.

FIG. 28C is a plan view of the heat exhaust duct.

FIG. 28D is a side view of the heat exhaust duct.

FIG. 29 is a schematic cross-sectional view of an image forming apparatus according to embodiment 14.

FIG. 30A is a front view of a heat exhaust duct according to embodiment 14.

FIG. 30B is a plan view of the heat exhaust duct.

FIG. 30C is a side view of the heat exhaust duct.

FIG. 31A is a perspective view of the heat exhaust duct according to embodiment 14.

FIG. 31B is another perspective view of the heat exhaust duct.

FIG. 32 is a schematic cross-sectional view illustrating a vicinity of a heat exhaust duct according to embodiment 15.

FIG. 33A is a perspective view of a heat exhaust duct according to embodiment 15.

FIG. 33B is a front view of the heat exhaust duct.

FIG. 33C is a plan view of the heat exhaust duct.

FIG. 33D is a side view of the heat exhaust duct.

FIG. 34 is a schematic cross-sectional view illustrating a vicinity of a heat exhaust duct according to embodiment 16.

FIG. 35A is a perspective view of the heat exhaust duct according to embodiment 16.

FIG. 35B is a front view of the heat exhaust duct.

FIG. 35C is a plan view of the heat exhaust duct.

FIG. 35D is a side view of the heat exhaust duct.

FIG. 36 is a schematic cross-sectional view illustrating a vicinity of a heat exhaust duct according to embodiment 17.

FIG. 37A is a perspective view of the heat exhaust duct according to embodiment 17.

FIG. 37B is a front view of the heat exhaust duct.

FIG. 37C is a plan view of the heat exhaust duct.

FIG. 37D is a side view of the heat exhaust duct.

FIG. 38 is a schematic cross-sectional view illustrating a vicinity of a heat exhaust duct according to embodiment 18.

FIG. 39A is a perspective view of the heat exhaust duct according to embodiment 18.

FIG. 39B is a front view of the heat exhaust duct.

FIG. 39C is a plan view of the heat exhaust duct.

FIG. 39D is a side view of the heat exhaust duct.

FIG. 40 is a schematic cross-sectional view illustrating a vicinity of a heat exhaust duct according to embodiment 19.

FIG. 41A is a perspective view of the heat exhaust duct according to embodiment 19.

FIG. 41B is a front view of the heat exhaust duct.

FIG. 41C is a plan view of the heat exhaust duct.

FIG. 41D is a side view of the heat exhaust duct.

FIG. 42 is a schematic cross-sectional view illustrating a vicinity of a heat exhaust duct according to embodiment 20.

FIG. 43A is a perspective view of the heat exhaust duct according to embodiment 20.

FIG. 43B is a front view of the heat exhaust duct.

FIG. 43C is a plan view of the heat exhaust duct.

FIG. 43D is a side view of the heat exhaust duct.

FIG. 44A is a side view of a heat exhaust duct according to modified example 1.

FIG. 44B is a side view of a heat exhaust duct according to modified example 2.

FIG. 44C is a side view of a heat exhaust duct according to modified example 3.

FIG. 44D is a side view of a heat exhaust duct according to modified example 4.

### DESCRIPTION OF THE EMBODIMENTS

Embodiments for carrying out the present invention will be described in detail below with reference to the drawings. The dimensions, materials, shapes and relative arrangements of components taught in the present description may be varied arbitrarily according to the configuration of the apparatus to which the present technique is applied or according to various conditions, and they are not intended to limit the scope of the present invention to the embodiments described below.

### Embodiment 1

### Entire Configuration of Image Forming Apparatus

At first, one example of an entire configuration of an image forming apparatus according to the present embodiment will be described. An image forming apparatus A according to the present embodiment is a laser printer adopting an electrophotographic system. The image forming apparatus refers to an apparatus that forms an image on a sheet serving as a recording medium based on an image information entered from an external PC or an image information read from a document, and includes a printer, a copying machine, a facsimile, and a malfunction copying machine. In addition to a main body having an image forming function, the image forming apparatus may have auxiliary devices such as an option feeder, an image reading apparatus, and a sheet processing apparatus connected thereto, in which case the entire system having the auxiliary device connected thereto is also recognized as one type of image forming apparatuses. Further, the image forming apparatus includes an image forming unit that may form a monochromatic toner image or a full-color toner image on the recording material serving as the sheet.

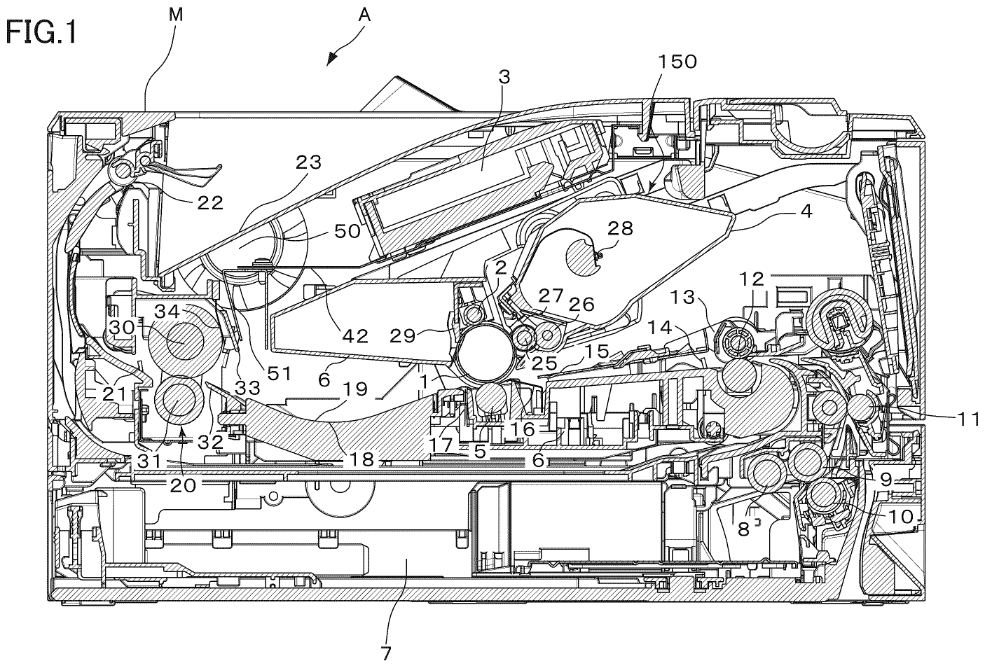

FIG. 1 is a schematic cross-sectional view of the image forming apparatus A according to embodiment 1. As illustrated in FIG. 1, the image forming apparatus A includes a photosensitive drum 1, which is a drum-shaped or cylindrical electrophotographic photoreceptor, serving as an image bearing member. The photosensitive drum 1 is supported rotatably on an apparatus body M of the image forming apparatus A, and driven to rotate by a driving source not shown. On the periphery of the photosensitive drum 1 are disposed a charging roller 2, an exposing unit 3, a developing unit 4, a transfer roller 5, and a cleaning unit 6 in the named order along a direction of rotation of the photosensitive drum 1.

Further, a recording material cassette 7 that stores recording materials P such as paper is disposed at a lower portion in the drawing of the apparatus body M. From the recording material cassette 7 along a conveyance path of the recording material P are disposed, in the named order, a pickup roller 8, a feed roller 9, a retard roller 10, a conveyance roller pair 11, a registration roller pair 12, a registration roller shutter 13, a top sensor 14, a pre-transfer upper guide 15, a pre-transfer lower guide 16, the transfer roller 5, a destaticizing needle 17, a conveyance guide 18, an attraction metal plate 19, a pre-fixing guide 32, a fixing device 20, a sheet discharge sensor 21, a sheet discharge roller pair 22, and a sheet discharge tray 23. The photosensitive drum 1, the charging roller 2, the exposing unit 3, the developing unit 4, the transfer roller 5, the cleaning unit 6, and the exposing unit 3 described later constitute an image forming unit 150 for forming an image, i.e., toner image, on the recording material P.

Next, an image forming operation will be described. The photosensitive drum 1 is driven to rotate at a process speed, i.e., peripheral speed, of 280 mm/second in a clockwise direction of FIG. 1 by a driving source not shown. In the present embodiment, an outer diameter of the photosensitive drum 1 is 24 mm. A surface of the photosensitive drum 1 being rotated is charged approximately uniformly to a predetermined potential with a predetermined polarity, which according to the present embodiment is negative polarity, by the charging roller 2. In this state, charging bias, i.e., charging voltage, is applied to the charging roller 2 from a charging power supply, i.e., high voltage power supply, not shown. Image exposing light is irradiated based on an image information entered from a host computer not shown by the exposing unit 3 on the surface of the photosensitive drum 1 being charged, and by having negative charge eliminated from the portion being exposed, an electrostatic latent image, i.e., electrostatic image, is formed.

The electrostatic latent image formed on the photosensitive drum 1 is developed as a toner image by the developing unit 4. The developing unit 4 adopts a contact developing system as the developing system. A stirring rod 28 is disposed on an inner side of a developing container of the developing unit 4. The stirring rod 28 rotates in a clockwise direction in the drawing to temporarily pool toner not shown in a vicinity area of a contact portion between a developing roller 25 and a toner supply roller 26. The toner being pooled temporarily is supplied by the toner supply roller 26 that is rotated counterclockwise in the drawing so as to be borne on the developing roller 25.

By having the developing roller 25 rotate counterclockwise, toner supplied to the developing roller 25 passes through a developing blade 27, i.e., regulation member, to be coated to an appropriate layer thickness. In this state, toner supplied to the developing roller 25 slides against the surface of the developing blade 27 and charged to negative polarity.

Toner coated on the developing roller 25 is conveyed to a developing nip where the photosensitive drum 1 and the developing roller 25 oppose each other. In the developing nip, a part of toner coated on the developing roller 25 is transferred to the photosensitive drum 1 by an electrostatic latent image potential formed on the photosensitive drum 1 by the exposing unit 3 and an electric field formed by a developing bias, i.e., developing voltage, applied to the developing roller 25 from a developing power supply not shown. Thus, by attaching toner charged to the same polarity as the charge polarity of the photosensitive drum 1 to the exposed portion on the photosensitive drum 1, i.e., reversal development system, the electrostatic latent image is developed as a toner image, i.e., visible image. That is, the developing roller 25 serving as a developing member forms a toner image on the photosensitive drum 1 by supplying toner onto the photosensitive drum 1.

Toner that remains on the developing roller 25 without being used for developing image at the developing nip is removed by the toner supply roller 26 being rotated at the contact portion between the developing roller 25 and the toner supply roller 26. Simultaneously, toner being pooled at the vicinity area of the contact portion between the developing roller 25 and the toner supply roller 26 is newly supplied to the developing roller 25.

Toner image formed on the photosensitive drum 1 is transferred to the recording material P such as paper by the action of the transfer roller 5 serving as a transfer member. The transfer roller 5 is urged, i.e., pressed, toward the photosensitive drum 1 by a transfer pressure spring serving as an urging member not shown, to be in pressure contact with the photosensitive drum 1. Thereby, a transfer nip portion, which is a contact portion between the photosensitive drum 1 and the transfer roller 5, is formed. The transfer nip portion nips and conveys the recording material P.

The transfer roller 5 is driven to rotate by the rotation of the photosensitive drum 1. In the present embodiment, an outer diameter of the transfer roller 5 is 14.0 mm. The transfer roller 5 nips and conveys the recording material P together with the photosensitive drum 1. In this state, a transfer bias, i.e., transfer voltage, which is a DC voltage having opposite polarity as a charge polarity of toner, i.e., regular charge polarity, during image development is applied to the transfer roller 5 from a transfer power supply, i.e., high voltage power supply, not shown. Thereby, toner image on the photosensitive drum 1 is transferred to a predetermined position on the recording material P. Transfer residual toner of the image being formed remains on the photosensitive drum 1 after transfer, which is collected by the cleaning unit 6.

A cleaning blade 29 serving as a cleaning member is disposed on the cleaning unit 6, and the cleaning blade 29 includes a support sheet metal and a rubber portion having elasticity fixed to a tip of the support sheet metal. A tip of the rubber portion disposed on a free end side of the cleaning blade 29 is abutted against the photosensitive drum 1 in a counter direction, by which the cleaning blade 29 removes transfer residual toner remaining on the photosensitive drum 1. Further, space i.e., waste toner container, for storing waste toner that has been collected is disposed on the cleaning unit 6.

The recording material P is supported on the recording material cassette 7, and the recording material P is fed by the pickup roller 8. The recording material P fed by the pickup roller 8 is sent out one at a time at a separation nip portion formed by the feed roller 9 and the retard roller 10.

Further, the recording material P is conveyed at a predetermined timing by the conveyance roller pair 11 and the registration roller pair 12, and guided by the pre-transfer upper guide 15 and the pre-transfer lower guide 16 to reach the transfer nip portion. By having a toner image transferred onto the recording material P at the transfer nip portion, an image is formed on the recording material P.

Next, the operation of the image forming apparatus A after having an image formed on the recording material P will be described. The amount of charge formed by applying transfer voltage on the surface of the recording material P having a toner image transferred thereto at the transfer nip portion is reduced by the destaticizing needle 17. Thereafter, the recording material P is guided by the conveyance guide 18 and the pre-fixing guide 32 to be conveyed to the fixing device 20. The attraction metal plate 19 disposed on the conveyance guide 18 exerts a force to attract the charged recording material P, by which the recording material P may be conveyed more stably.

The fixing device 20 serving as a fixing unit includes a heating roller 30 and a pressure roller 31. The heating roller 30 serving as a fixing member is supported rotatably on a frame of the fixing device 20, and driven to rotate by a driving source not shown. The pressure roller 31 is in pressure contact with the heating roller 30 by a fixing and pressing spring serving as an urging member not shown. Thereby, the heating roller 30 and the pressure roller 31 come into contact with each other to form a fixing nip portion. The heating roller 30 may be heated by a heat source not shown. A thermistor 34 is attached to the heating roller 30, and based on the detection result of the thermistor 34, temperature of the heating roller 30 is controlled. The recording material P is heated while being nipped and conveyed at the fixing nip portion.

The unfixed toner image formed on the recording material P is melted by being fixed and pressed at the fixing device 20, and thereby fixed onto the surface of the recording material P as a fixed image. The recording material P having the toner image fixed thereto at the fixing device 20 is discharged by the sheet discharge roller pair 22 onto the sheet discharge tray 23 disposed on the upper surface of the apparatus body M. Further, the image forming apparatus A is capable of confirming the occurrence of a jam, i.e., sheet jam, by sensing the leading end and the trailing end of the recording material P through the top sensor 14 and the sheet discharge sensor 21.

Further, the image forming apparatus A is equipped with a heat exhaust fan 50 and a heat exhaust duct 51 described later, and an air passage formed by the heat exhaust duct 51 is disposed between the cleaning unit 6 and the fixing device 20. Therefore, heat generated at the fixing device 20 and the image forming unit 150 may be discharged effectively. The airflow will be described in detail below.

### Airflow

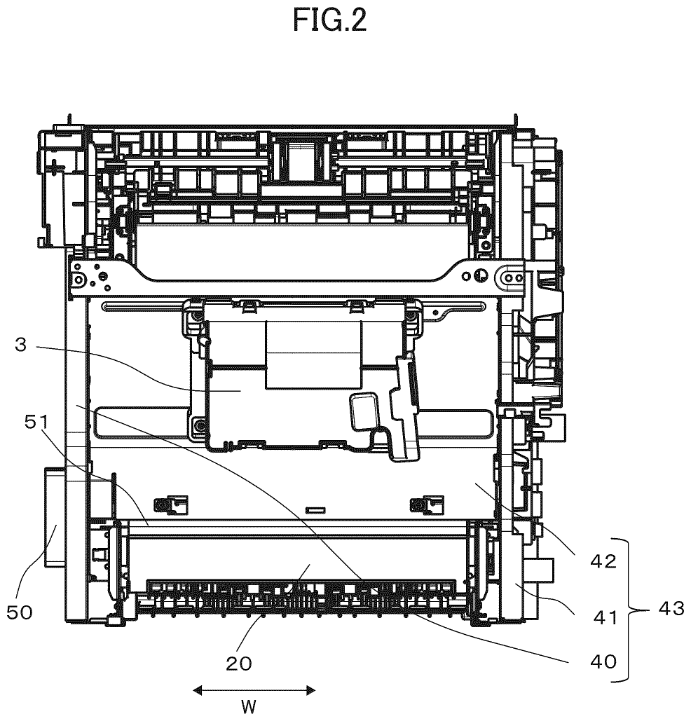

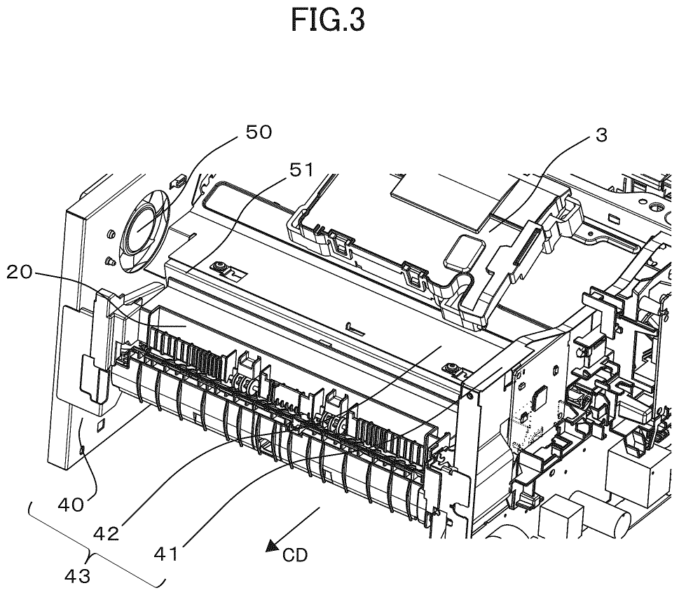

The airflow in the image forming apparatus A according to the present embodiment will be described. FIG. 2 is a front view of the image forming apparatus A according to embodiment 1, and FIG. 3 is a perspective view of the image forming apparatus A according to embodiment 1. In FIGS. 2 and 3, components in the vicinity of the sheet discharge roller pair 22 and the sheet discharge tray 23 are not shown for explanation.

As illustrated in FIGS. 2 and 3, a main body frame 43 is composed of a right side plate 40, a left side plate 41, and a scanner stay 42, wherein the right side plate 40 and the left side plate 41 are connected by the scanner stay 42. The main body frame 43 is a structure that constitutes a frame of the image forming apparatus A, and a width of the main body frame 43 is substantially the same as an entire width of the image forming apparatus A in a width direction W that is orthogonal to a conveyance direction CD of the recording material P.

The scanner stay 42 serving as a support member supports the exposing unit 3 that irradiates laser light to the photosensitive drum 1. The fixing device 20 is attached to the main body frame 43 of the image forming apparatus A and fixed thereto by a fixing screw not shown. Therefore, the fixing device 20 may be detached from the main body frame 43 of the image forming apparatus A by removing the fixing screw not shown during maintenance.

The heat exhaust fan 50 is a fan having an outer size of 60 mm×60 mm and fixed to the right side plate 40 at a corresponding position between the cleaning unit 6 and the fixing device 20. That is, the heat exhaust fan 50 is arranged on one side of the heat exhaust duct 51 in the width direction W. Further, the heat exhaust fan 50 has a function to discharge the air within the image forming apparatus A to the exterior of the apparatus. In the following description, regarding the body frame 43, the right side plate 40 side is referred to as a drive side, and the surface of the right side plate 40 on which the heat exhaust fan 50 is attached is referred to as a drive side surface. This is the right side surface when viewed from a front side of the image forming apparatus A, that is, an upstream side in the conveyance direction CD of the recording material P during image forming. Further, in contrast, the left side when viewed from the front side of the image forming apparatus A, that is, the left side plate 41 side, is referred to as an electronic component side, and the left side surface of the left side plate 41 is referred to as an electronic component side surface.

The heat exhaust duct 51 serving as a duct is arranged at a center portion in the width direction W of the image forming apparatus A at a corresponding position between the cleaning unit 6 and the fixing device 20. The heat exhaust duct 51 is attached to the scanner stay 42. The heat exhaust duct 51 forms an air passage for discharging the air on the electronic component side to the exterior of the apparatus by enabling air to pass through from the electronic component side to the drive side. Detailed functions of the heat exhaust duct 51 will be described below.

Next, a heat source of the image forming apparatus A and the airflow corresponding thereto will be described. The developing unit 4, the cleaning unit 6, and the exposing unit 3 of the image forming unit 150 generate heat along with the image forming operation. Further, the fixing device 20 includes a heating body, such that heat is generated by heating the heating body. The heat generated by the heating body may be discharged to the exterior of the device by the discharging of air by the heat exhaust fan 50.

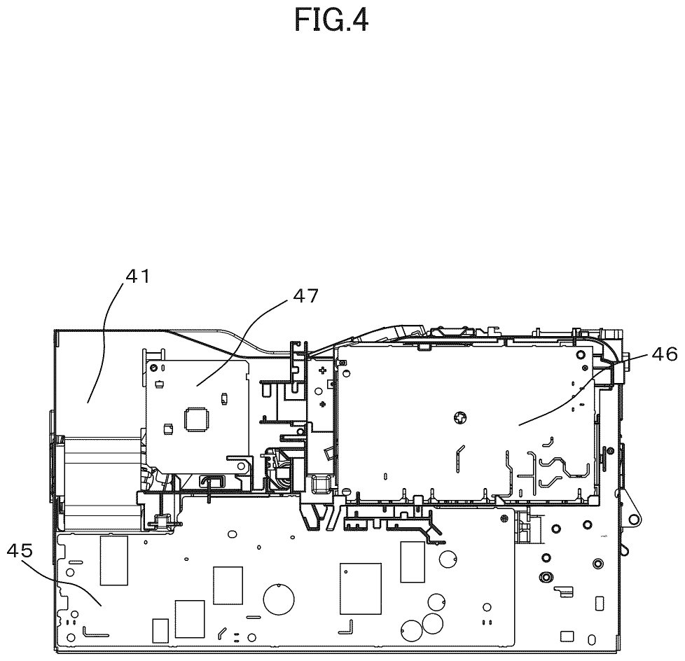

FIG. 4 is a left side view of the image forming apparatus A according to embodiment 1. As illustrated in FIG. 4, a low voltage power supply 45, a control board 46, and an image signal generation board 47 are attached to the left side plate 41. The low voltage power supply 45 is arranged at a lower portion of the electronic component side surface of the left side plate 41, and the low voltage power supply 45 converts an AC voltage supplied from an inlet as required and supplies necessary power for the image forming operation including driving and heating. The control board 46 is arranged at a front direction at the upper portion of the electronic component side surface of the left side plate 41. The control board 46 is composed of a control unit (not shown) and a high voltage unit (not shown). The control unit performs control of the image signal generation board 47 and the entire image forming apparatus A. The high voltage unit is a generation unit of voltage required for forming image composed of the aforementioned charging power supply, a developing power supply, and a transfer power supply. The image signal generation board 47 is a generation unit of VDO signals that have been modulated according to time-series electrical digital pixel signals of print data, i.e., image information, entered from a host computer (not shown). The exposing unit 3 controls ON/OFF of light based on the VDO signals. Heat generation by losses occurs through use of the low voltage power supply 45, the control board 46, and the image signal generation board 47 during the image forming operation.

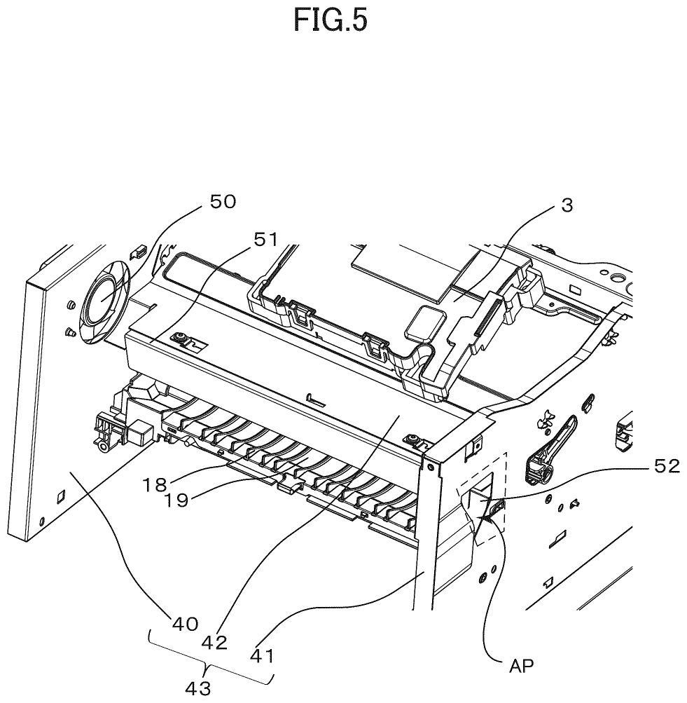

FIG. 5 is a perspective view of a vicinity of the main body frame 43 according to embodiment 1, which illustrates a state where components of the fixing device 20, the low voltage power supply 45, the control board 46, and the image signal generation board 47 have been removed from FIG. 3. FIG. 5 illustrates the main body frame 43, the conveyance guide 18, the attraction metal plate 19, the exposing unit 3, and the heat exhaust duct 51.

As illustrated in FIG. 5, a vent hole 52 is disposed on the left side plate 41, wherein the vent hole 52 is at a position corresponding to the electronic component side of the heat exhaust duct 51. Heat generated from the electronic component side, such as the low voltage power supply 45, may be discharged through the vent hole 52 and the heat exhaust duct 51 by air discharge of the heat exhaust fan 50. According to the airflow described above, heat generated in respective areas during the image forming operation may be discharged preferably without remaining within the image forming apparatus A.

### Heat Exhaust Duct

The heat exhaust duct 51 according to the present embodiment forms an air passage AP that is communicated from the electronic component side to the drive side, and efficiently suppresses exhaust heat of the fixing device 20 from being conducted to the cleaning unit 6.

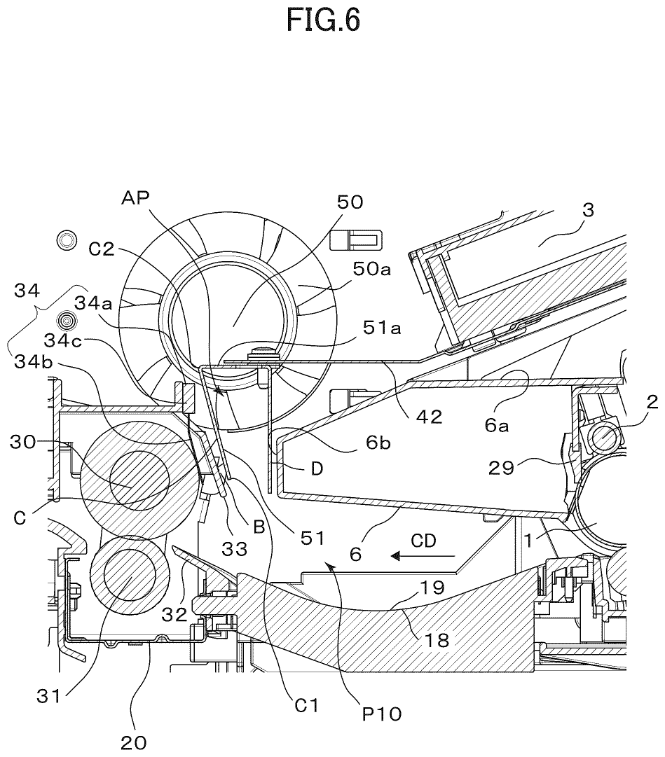

FIG. 6 is a schematic cross-sectional view illustrating a vicinity of the heat exhaust duct 51 according to embodiment 1. As illustrated in FIG. 6, the heat exhaust duct 51 is arranged in the vicinity of a fixing cover 33 of the fixing device 20 and in the vicinity of the cleaning unit 6. At first, the fixing cover 33 will be described. The fixing cover 33 is arranged in the vicinity of the heating roller 30 and covers the heating roller 30. The fixing cover 33 prevents the user from touching the heating roller 30 that is heated, and also suppresses the generation of damage of the heating roller 30 caused by the user touching the heating roller 30. The fixing cover 33 is composed, for example, of a resin material having superior heat resisting property and electric insulation property, such as a polycarbonate.

In the present embodiment, a center of the heat exhaust fan 50 is arranged on an upper surface side and the front side of the apparatus body M with respect to a center of the fixing device 20. The heat exhaust duct 51 is arranged in an overlapped manner with the heat exhaust fan 50 serving as a fan when viewed in the width direction W. Further, the heat exhaust duct 51 is arranged on a same side as a container 6a of the cleaning unit 6 with respect to a conveyance path P10 described later.

It is characteristic that a shape of the front side of the fixing cover 33 is extended from the upper side toward the lower side. Specifically, a planar portion B is formed on a front side of the fixing cover 33, and the planar portion B forms an angle of 71° with respect to a horizontal surface. This is to conduct the heat of the fixing device 20 efficiently to the heat exhaust duct 51 while preventing the heat from being conducted to the cleaning unit 6. The details of the effects will be described below.

The conveyance path P10 through which sheets are passed is formed between the transfer roller 5 and the fixing device 20. In other words, the conveyance path P10 is a conveyance path through which sheets pass between the transfer nip portion and the fixing nip portion. Further, in the heat exhaust duct 51, a first wall portion C adjacent to the planar portion B of the fixing cover 33 includes a first end portion C1 closest to the conveyance path P10 and a second end portion C2 closest to the conveyance path P10. The second end portion C2 is connected to an upper surface 51a.

A distance between the planar portion B of the fixing cover 33 and a portion of the first wall portion C of the heat exhaust duct 51 adjacent to the planar portion B of the fixing cover 33 is set to be 3.0 mm or smaller. More specifically, a distance between the planar portion B and the first end portion C1 of the first wall portion C which is the nearest portion is 1.5 mm, and a distance between the planar portion B and the second end portion C2 of the first wall portion C which is the farthest portion is 2.5 mm. Further, by arranging the heat exhaust duct 51 composed of a metal plate, i.e., metal material, between the fixing device 20 and the cleaning unit 6, the heat from the fixing device 20 is suppressed from being conducted directly to the cleaning unit 6. The cleaning unit 6 includes the container 6a that accommodates transfer residual toner, and the container 6a includes a surface 6b that is opposed and adjacent to the heat exhaust duct 51. The container 6a serving as a toner collecting container collects toner removed by the cleaning blade 29 from the surface of the photosensitive drum 1. A distance between a second wall portion D of the heat exhaust duct 51 that is adjacent to the surface 6b of the container 6a of the cleaning unit 6 and the surface 6b is 2.0 mm. The second wall portion D extends to a position close to the conveyance path P10 than the cleaning blade 29 when viewed in the width direction W.

As described above, the pre-fixing guide 32 is disposed on a side opposite to the cleaning unit 6 with respect to the conveyance path P10. The pre-fixing guide 32 serving as a guide member is arranged to be overlapped with the fixing device 20 in the conveyance direction CD, and guides the recording material P toward the fixing nip portion of the fixing device 20. The heat exhaust duct 51 is arranged to be overlapped with the pre-fixing guide 32 in the conveyance direction CD.

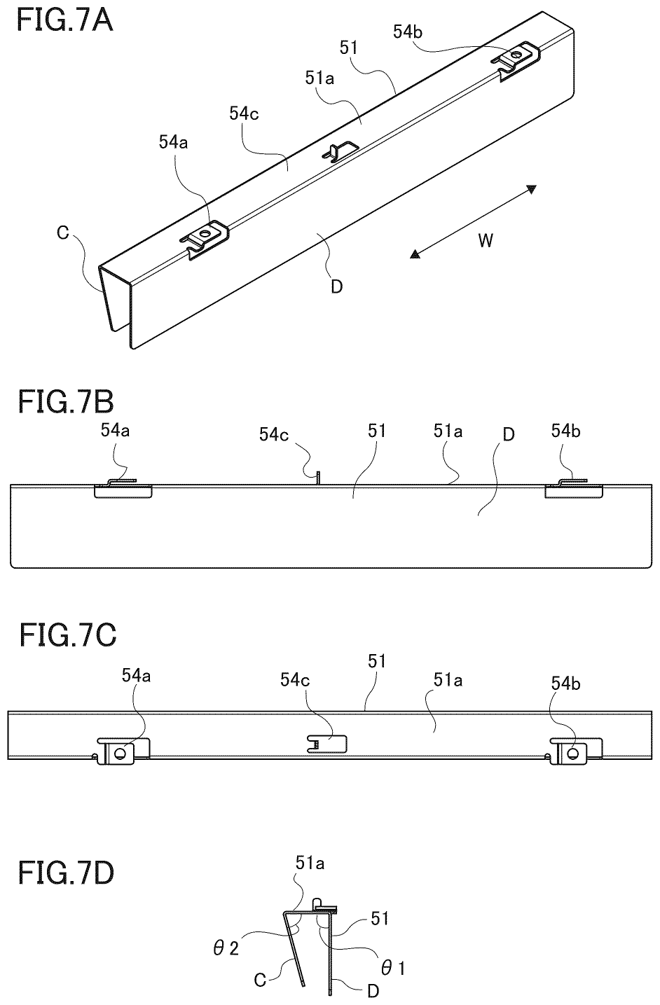

FIG. 7A is a perspective view of the heat exhaust duct 51 according to embodiment 1, and FIG. 7B is a front view of the heat exhaust duct 51. FIG. 7C is a plan view of the heat exhaust duct 51, and FIG. 7D is a side view of the heat exhaust duct 51.

As illustrated in FIGS. 7A to 7D, the heat exhaust duct 51 extends such that the width direction W is a longitudinal direction. The heat exhaust duct 51 includes the first wall portion C opposed to the planar portion B of the fixing cover 33, the second wall portion D opposed to the cleaning unit 6, and the upper surface 51a that connects the first wall portion C and the second wall portion D. In other words, the heat exhaust duct 51 includes the first wall portion C opposed to the fixing device 20, the second wall portion D opposed to the container 6a, and the upper surface 51a. The upper surface 51a is provided with mounting portions 54a and 54b, and a positioning portion 54c.

The heat exhaust duct 51 is attached by sliding in a thrust direction, i.e., the width direction W, on the scanner stay 42 of the main body frame 43. By having the heat exhaust duct 51 attached by sliding on the scanner stay 42, the positioning portion 54c abuts against an abutment portion of the scanner stay 42, and the heat exhaust duct 51 is thereby positioned on the scanner stay 42. In this state, the mounting portions 54a and 54b are engaged to the scanner stay 42 by fixing screws, such that the heat exhaust duct 51 is fixed to the scanner stay 42.

The second wall portion D disposed on a front side of the heat exhaust duct 51 adjacent to the cleaning unit 6 has a cross-sectional length of 32 mm orthogonal to the width direction W. According to the present embodiment, the upper surface 51a extends in a horizontal direction, and an angle θ1 formed by the second wall portion D and the upper surface 51a of the heat exhaust duct 51 is 90°. That is, the second wall portion D extends in a vertical direction. The length of the first wall portion C that is on the rear side of the heat exhaust duct 51 and that is adjacent to the fixing cover 33 is 30 mm in a cross section orthogonal to the width direction W. An angle θ2 that is formed by the first wall portion C and the upper surface 51a of the heat exhaust duct 51 is 75°. That is, the first wall portion C extends linearly in a direction orthogonal to the vertical direction when viewed in the width direction W parallel to the rotational axis direction of the photosensitive drum 1. The width direction W may also be referred to as the rotational axis direction of the photosensitive drum 1.

That is, the first wall portion C is inclined with respect to the second wall portion D. In further detail, the first wall portion C is inclined with respect to the second wall portion D such that a distance between the first end portion C1 of the first wall portion C and the second wall portion D is shorter than a distance between the second end portion C2 of the first wall portion C and the second wall portion D.

### Effects of Embodiment 1

The effects of the present embodiment will be described. According to the present embodiment, the planar portion B of the fixing cover 33 is inclined from a perpendicular direction, i.e., vertical direction or gravity direction, and the first wall portion C of the heat exhaust duct 51 is disposed adjacent to the planar portion B. Thereby, a large amount of air may be flown through the heat exhaust duct 51 to discharge a greater amount of heat of the fixing device 20 while reducing the heat conducted to the cleaning unit 6.

The planar portion B serving as an opposing surface of the fixing cover 33 is opposed to the first wall portion C and extends along the first wall portion C. That is, by arranging the planar portion B of the fixing cover 33 adjacent to the heat exhaust duct 51, heat of the fixing cover 33 that has been heated by the heating roller 30 may be conducted efficiently to the heat exhaust duct 51. According to the present embodiment, the first wall portion C of the heat exhaust duct 51 is inclined from the perpendicular direction, i.e., vertical direction or gravity direction, along the planar portion B. Thereby, the portion of the air passage AP formed by the heat exhaust duct 51 that is overlapped with a fin 50a of the heat exhaust fan 50, that is, the space into which heat may be discharged through the heat exhaust fan 50, may be widened, and the heat of the heat exhaust duct 51 may be reduced further.

In the field of image forming apparatuses, the amount of heat generated by the fixing device has been increased so as to enhance productivity, and further, the cleaning device and the fixing device tend to be arranged adjacently in order to downsize the apparatus. However, when the temperature of the cleaning device rises by the heat of the fixing device, transfer residual toner stored inside the cleaning device may be aggregated. If transfer residual toner is aggregated in the cleaning device, transfer residual toner having been removed by the cleaning blade from the photosensitive drum may leak from the cleaning device.

By configuring the fixing cover 33 and the heat exhaust duct 51 as according to the present embodiment, rising of temperature of the cleaning unit 6 may be suppressed, and aggregation of transfer residual toner and leaking thereof from the cleaning unit 6 may be suppressed.

A secondary effect thereof will be described. The thermistor 34 that detects the temperature of the heating roller 30 includes a base 34a attached to the fixing cover 33, an arm portion 34b extending downward from the base 34a, and a temperature detection portion 34c disposed within the base 34a. The arm portion 34b is disposed elastically deformably such that it may be stably abutted against the heating roller 30. The arm portion 34b is connected in a manner capable of transmitting heat to the temperature detection portion 34c. In the present embodiment, the temperature detection portion 34c is disposed on the base 34a, but the present technique is not limited thereto, and the temperature detection portion 34c may be disposed on an outer portion of the base 34a.

As described, the thermistor 34 is capable of detecting the temperature of the heating roller 30, but a problem arises that the detected temperature may be deviated slightly by the temperature around the heating roller 30, especially the temperature of the fixing cover 33. This is because the state of heat transmission to the temperature detection portion 34c may be varied by the influence of change of ambient temperature of the base 34a and the arm portion 34b of the thermistor 34 or the circumference thereof.

Even in cases where the temperature of the heating roller 30 is completely the same, if the temperature of the fixing cover 33 or the ambient temperature around the base 34a, the arm portion 34b, and the temperature detection portion 34c of the thermistor 34 rises, flowing in of heat through the heat transmission passage to the temperature detection portion 34c is reduced, and the detected temperature of the thermistor 34 is somewhat increased. This means that the detected temperature of the thermistor 34 for optimum fixing of toner image to the recording material P changes between a state where the fixing cover 33 is cooled and a state where it is heated. This may lead to reduction of margin regarding defects that occur when the temperature of the heating roller 30 is high or defects that occur when the temperature thereof is low. For example, if the temperature of the heating roller 30 is high, defects such as the recording material P being wound around the heating roller 30 and causing jamming of sheets may occur, whereas if the temperature of the heating roller 30 is low, defects such as the toner image not being fixed sufficiently to the recording material P may occur.

As according to the present embodiment, by inclining the planar portion B of the fixing cover 33 from the perpendicular orientation, and by arranging the first wall portion C of the heat exhaust duct 51 adjacently with the planar portion B, the amount of temperature change of the fixing cover 33 due to the state of use of the image forming apparatus A may be reduced. As a result, the occurrence of winding of the recording material P around the heating roller 30 or fixing failures, such as blister images and cold offsets, caused by insufficient fixing temperature due to the state of use of the image forming apparatus A may be suppressed.

### Confirmation of Effect of Embodiment 1

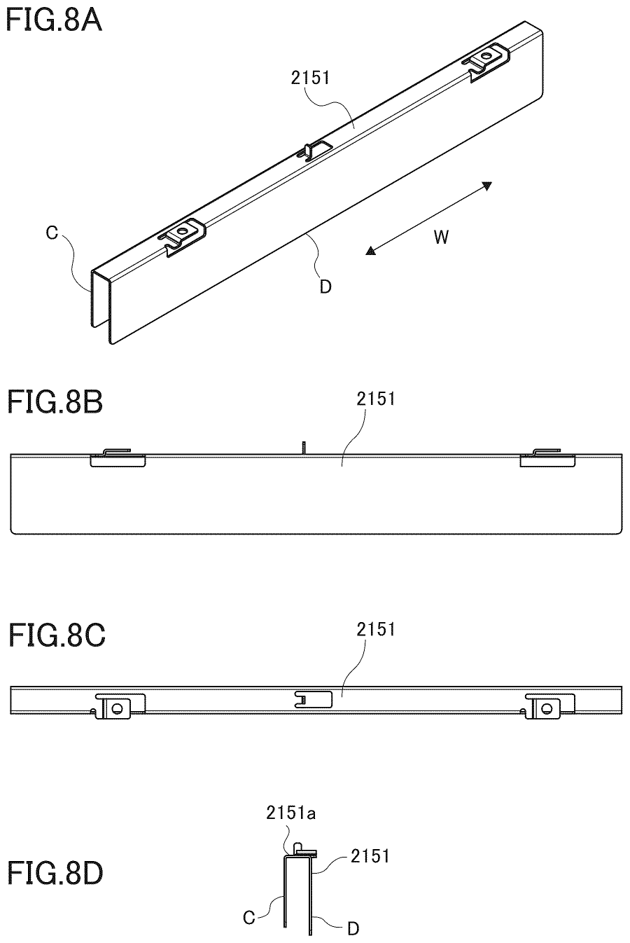

Next, a result of an image output experiment for confirming the effect of the present embodiment will be described. The image output experiment has been performed to the present embodiment and comparative examples 1 and 2. FIG. 8A is a perspective view of a heat exhaust duct 2151 according to comparative example 1, and FIG. 8B is a front view of the heat exhaust duct 2151. FIG. 8C is a plan view of the heat exhaust duct 2151, and FIG. 8D is a side view of the heat exhaust duct 2151. As illustrated in FIGS. 8A to 8D, an angle formed by an upper surface 2151a and the first wall portion C of the heat exhaust duct 2151 is 90°, and a length of the first wall portion C at a cross section orthogonal to the width direction W is 30 mm. An angle formed by the upper surface 2151a and the second wall portion D is 90°, and a length of the second wall portion D at a cross section orthogonal to the width direction W is 32 mm. A distance between the planar portion B of the fixing cover 33 and the first wall portion C at the nearest portion is 1.5 mm, and the distance therebetween at the farthest portion is 4.0 mm.

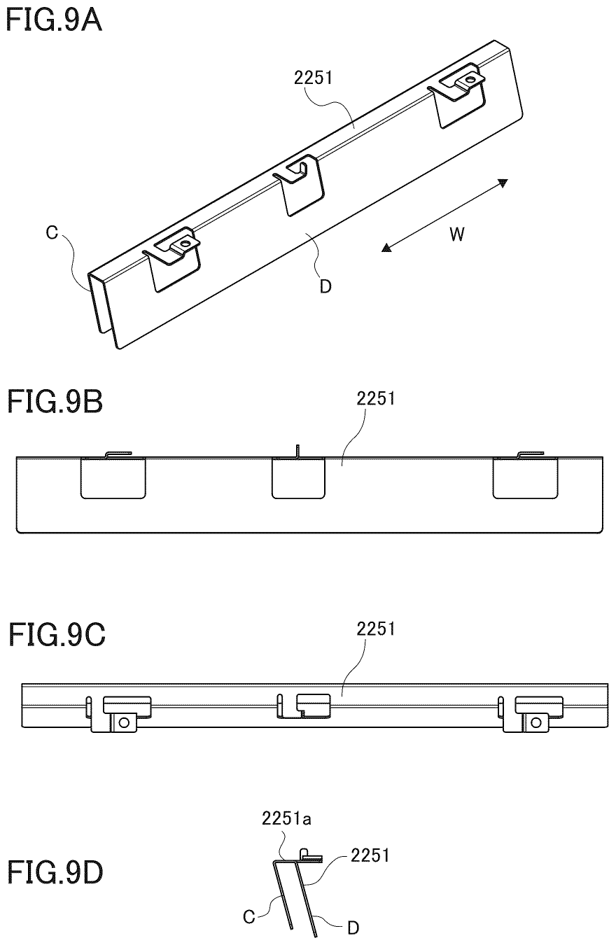

FIG. 9A is a perspective view of a heat exhaust duct 2251 according to comparative example 2, and FIG. 9B is a front view of the heat exhaust duct 2251. FIG. 9C is a plan view of the heat exhaust duct 2251, and FIG. 9D is a side view of the heat exhaust duct 2251. As illustrated in FIGS. 9A to 9D, an angle formed by an upper surface 2251a of the heat exhaust duct 2251 and the first wall portion Cis 75°, and a length of the first wall portion C at a cross section orthogonal to the width direction W is 30 mm. An angle formed by the upper surface 2251a and the second wall portion D is 75°, and a length of the second wall portion D at a cross section orthogonal to the width direction W is 32 mm. A distance between the planar portion B of the fixing cover 33 and the first wall portion C at the nearest portion is 1.5 mm, and the distance therebetween at the farthest portion is 2.5 mm.

Table 1 shows the summarized results of the configurations of the present embodiment and the comparative examples 1 and 2 described above.

TABLE 1

| | FIRST WALL PORTION | | | | | |
|---|---|---|---|---|---|---|
| | | | DISTANCE | DISTANCE | SECOND WALL PORTION | |
| | | | FROM | FROM | | ANGLE |
| | | ANGLE FORMED | FIXING | FIXING | | FORMED |
| | LENGTH | BETWEEN UPPER | COVER AT | COVER AT | LENGTH | BETWEEN |
| | IN CROSS- | SURFACE OF | NEAREST | FARTHEST | IN CROSS- | FIXING |
| | SECTION | FIXING COVER | PORTION | PORTION | SECTION | COVER |
| EMBODIMENT 1 | 30 mm | 75° | 1.5 mm | 2.5 mm | 32 mm | 90° |
| COMPARATIVE | 30 mm | 90° | 1.5 mm | 4.0 mm | 32 mm | 90° |
| EXAMPLE 1 | | | | | | |
| COMPARATIVE | 30 mm | 75° | 1.5 mm | 2.5 mm | 32 mm | 75° |
| EXAMPLE 2 | | | | | | |

Configurations and operations of the image forming apparatus according to comparative examples 1 and 2 are approximately the same as the image forming apparatus A according to the present embodiment, apart from the differences described above.

At first, an image output experiment regarding “toner leakage” will be described. An evaluation experiment of toner leakage will be described. A Canon Red Label (product name, Canon E.U.) having a grammage of 80 g/m2 and a sheet size of A4 was used as the recording material P.

In the image forming apparatus used for the experiment, a processing speed during the experiment was 280 mm/sec, and the throughput thereof was 50 images per minute. The set temperature of the fixing device 20 was 200° C. As for the atmospheric environment in which the experiment was performed, the temperature was 32.5° C. and the humidity was 80%.

After leaving the image forming apparatus in a power OFF state for one night and confirming that the temperature inside the apparatus is sufficiently close to the atmospheric environment, a lateral line image with an image coverage of 2% was printed by duplex continuous printing to 10,000 sheets, i.e., 20,000 images, and thereafter, whether toner leakage from the cleaning unit 6 has occurred within the image forming apparatus was confirmed.

Further, in order to quantify the effect of the experiment results, a thermocouple was made to come into contact with the planar portion B of the fixing cover 33, the first wall portion C, and the second wall portion D, to measure the highest temperatures that have been reached in each of the portions during printing.

The results of the image output experiments of “toner leakage” and temperatures measured according to the evaluation experiments performed using the image forming apparatuses of the present embodiment and the comparative examples 1 and 2 are shown in Table 2.

TABLE 2

| | | REACHED | | REACHED | | REACHED | |
|---|---|---|---|---|---|---|---|
| | | TEMPERATURE | | TEMPERATURE | | TEMPERATURE | |
| | TONER | OF FIXING | | OF FIRST WALL | | OF SECOND | |
| | LEAKAGE | COVER | | PORTION | | WALL PORTION | |
| EMBODIMENT 1 | ∘ | 65° | C. | 50.5° | C. | 45.5° | C. |
| COMPARATIVE | x | 71° | C. | 54° | C. | 51° | C. |
| EXAMPLE 1 | | | | | | | |
| COMPARATIVE | x | 71.5° | C. | 56.5° | C. | 53° | C. |
| EXAMPLE 2 | | | | | | | |

In the evaluation experiment of toner leakage according to the present embodiment, there was no occurrence of toner leakage. Meanwhile, toner leakage had occurred according to comparative example 1. Toner leakage had also occurred according to comparative example 2.

Next, the realized effects will be described based on the result of temperature being measured by the evaluation experiment of toner leakage. According to the present embodiment, the first wall portion C of the heat exhaust duct 51 was arranged adjacent to the planar portion B of the fixing cover 33, such that heat conducted to the cleaning unit 6 may be reduced by discharging a large amount of heat from the fixing device 20 while increasing the amount of air flowing through the heat exhaust duct 51.

Meanwhile, according to the comparative example, in comparison with the present embodiment, the planar portion B of the fixing cover 33 and the first wall portion C of the heat exhaust duct 2151 are not arranged adjacently. Further according to comparative example 1, in comparison with the present embodiment, the space, i.e., air passage, within the heat exhaust duct 2151 is narrow. When comparing the present embodiment and the comparative example 1, a difference between the reached temperature of the fixing cover 33 and the reached temperature of the first wall portion Cis 14.5° C. (=65° C.-50.5° C.) according to the present embodiment, which is lower than 17° C. (=71° C.-54° C.) according to comparative example 1. Since according to the present embodiment, the planar portion B of the fixing cover 33 and the first wall portion C of the heat exhaust duct 51 are arranged adjacently, the heat of the fixing device 20 may be more easily absorbed by the heat exhaust duct 51.

In the present embodiment, the difference between the temperature of the first wall portion C and the temperature of the second wall portion D is 5° C. (=50.5° C.-45.5° C.), whereas in comparative example 1, the difference is 3° C. (=54° C.-51° C.), such that the present embodiment realizes a temperature difference greater by 2° C. since the amount of air flowing through the heat exhaust duct 51 is increased according to the present embodiment, and greater amount of heat may be discharged through the heat exhaust duct 51.

Meanwhile, in comparative example 2, similar to the present embodiment, the planar portion B of the fixing cover 33 and the first wall portion C of the heat exhaust duct 2251 are arranged adjacently. The difference between the reached temperature of the fixing cover 33 and the reached temperature of the first wall portion Cis 14.5° C. (=65° C.-50.5° C.) according to the present embodiment, which is approximately equivalent to 15° C. (71.5° C.-65° C.) of comparative example 2.

However, in comparative example 2, the amount of flow passing through the heat exhaust duct 2251 is smaller compared to the present embodiment 1. Therefore, the temperature of the second wall portion D is 45.5° C. according to the present embodiment whereas it is as high as 53° C. according to comparative example 2. According to comparative example 2, the fixing cover 33 and the heat exhaust duct 2251 are disposed adjacently, such that the heat exhaust duct 2251 absorbs the heat of the fixing device 20, but the amount of air flow is not high, and the heat is conducted to the vicinity of the cleaning unit 6.

In the image output experiment exhibiting such states of heat discharge, the reached temperature of the second wall portion D is low according to the present embodiment whereas the reached temperature of the second wall portion D is high according to comparative examples 1 and 2, such that the transfer residual toner of the cleaning unit 6 is aggregated. It is considered that toner leakage has occurred since the transfer residual toner within the cleaning unit 6 got stuck and transfer residual toner had leaked out from the cleaning unit 6.

Next, image output experiments regarding “fixing failure” and “winding” are described. Similar to the experiments described above, the processing speed of the image forming apparatus was 280 mm/sec, and the throughput thereof was 50 images per minute. The temperature setting of the fixing device 20 was set to two temperatures, which were 200° C. and 195° C. As for the atmospheric environment in which the experiments were performed, the temperature was 23° C. and the humidity was 50%.

At first, an evaluation experiment of fixing failure will be described. A Hammermill Premium Color Copy 60 lb. Cover Paper (product name, Hammermill) having a grammage of 162 g/m2 and a sheet size of LTR was used as the recording material P.

After leaving the image forming apparatus in a power OFF state for one night and confirming that the temperature inside the apparatus is sufficiently close to the atmospheric environment, a full black image with an image coverage of 100% was printed by simplex continuous printing to 550 sheets, i.e., 550 images, and thereafter, whether fixing failure has occurred to the printed image was confirmed.

Next, an evaluation experiment regarding winding will be described. A CS-060F (product name, Canon Marketing Japan) having a grammage of 60 g/m² and a sheet size of A4 was used as the recording material P. After leaving the image forming apparatus in a power OFF state for one night and confirming that the temperature inside the apparatus is sufficiently close to the atmospheric environment, a full black image with an image coverage of 100% was printed by duplex continuous printing to 550 sheets, i.e., 1100 images, and while performing the printing, it was confirmed whether a sheet jamming phenomenon where the recording material was wound around the fixing device 20 has occurred.

Regarding the image forming apparatuses of the present embodiment and comparative examples 1 and 2, the set temperatures of the fixing device 20 and the results of the respective evaluation experiments are shown in Table 3.

TABLE 3

| | SET | FIXING | |
|---|---|---|---|
| | TEMPERATURE | FAILURE | WINDING |
| EMBODIMENT 1 | 195° C. | ∘ | ∘ |
| COMPARATIVE | 200° C. | ∘ | x |
| EXAMPLE 1 | 195° C. | x | ∘ |
| COMPARATIVE | 200° C. | ∘ | x |
| EXAMPLE 2 | 195° C. | x | ∘ |

According to the present embodiment, during the evaluation experiments of fixing failure and winding, fixing failure did not occur but winding had occurred at the set temperature of 200° C., whereas neither fixing failure nor winding failure have occurred at the set temperature of 195° C.

Meanwhile, according to comparative example 1, fixing failure has occurred at the set temperature of 195° C., and winding has occurred at the set temperature of 200° C. Further, according to comparative example 2, fixing failure has occurred at the set temperature of 195° C., and winding has occurred at the set temperature of 200° C.

Next, the effects having been achieved will be described based on the measured temperature in the evaluation experiments of toner leakage. Similar effects of the present embodiment regarding discharge of heat are realized in both the image output experiments of “fixing failure” and “winding”.

As have been described above in the image output experiment of “toner leakage”, the reached temperature of the fixing cover 33 was low according to the present embodiment, but the reached temperature of the fixing cover 33 was high according to comparative examples 1 and 2. In a state where the reached temperature of the fixing cover 33 is high, the detected temperature of the thermistor 34 becomes high, such that if the heating roller 30 is subjected to temperature control to achieve the same detected temperature in this state, the temperature of the heating roller 30 will become too low.

In a state where the set temperature is set to 195° C. in the image output experiments of comparative examples 1 and 2 where such heat discharge states are realized, it is considered that the temperature of the heating roller 30 had dropped to a level where fixing failure occurs in a state where the temperature of a temperature ripple accompanying temperature control of the heating roller 30 is low.

If the set temperature of the fixing device 20 is set to a high temperature of 200° C. to suppress the occurrence of fixing failures in comparative examples 1 and 2, harmful effects caused by the fixing temperature being too high in a state where the temperature of the fixing cover 33 is low have occurred. That is, according to the present embodiment, the temperature may be set to cause neither fixing failure nor winding from occurring by selecting a set temperature of 195° C., whereas according to comparative examples 1 and 2, no temperature setting enabled to prevent the occurrence of both defects.

As described above, by inclining the planar portion B of the fixing cover 33 from the perpendicular orientation and disposing the first wall portion C of the heat exhaust duct 51 adjacently to the planar portion B, a large amount of heat from the fixing device 20 may be discharged while increasing the amount of air flowing through the heat exhaust duct 51. Therefore, heat conducted to the cleaning unit 6 from the fixing device 20 may be reduced further, and heat may be discharged efficiently by a small sized configuration. In other words, the heat shielding performance of the heat from the fixing device 20 may be enhanced.

### Embodiment 2

Next, embodiment 2 of the present invention will be described. Embodiment 2 adopts a heat exhaust duct 151 that corresponds to a shape of a fixing cover 133 that differs from embodiment 1. Therefore, similar configurations as embodiment 1 are either not shown or denoted with the same reference numbers.

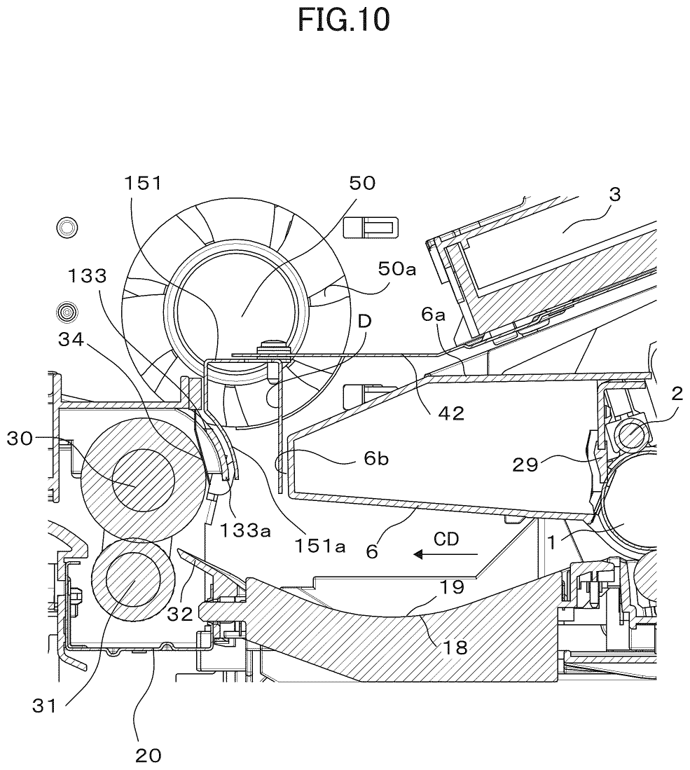

FIG. 10 is a schematic cross-sectional view of a vicinity of the heat exhaust duct 151 according to embodiment 2. As illustrated in FIG. 10, the fixing cover 133 includes an arc portion 133a that is positioned upstream of the heating roller 30 in the conveyance direction CD of the recording material P. The fixing cover 133 is composed of a resin material having superior heat resisting property and electric insulation property, such as polycarbonate. The arc portion 133a is arranged at a position separated approximately uniformly by 4 mm from the heating roller 30 so as to cover the surface of the heating roller 30. Further, the heat exhaust duct 151 serving as a duct includes an arc portion 151a that is positioned upstream of the fixing cover 133 in the conveyance direction CD, and the second wall portion D. The arc portion 151a serving as a first wall portion is disposed at a position separated approximately uniformly by 1.5 mm from the arc portion 133a so as to cover the arc portion 133a of the fixing cover 133. That is, the arc portion 133a serving as an opposing surface is opposed to the arc portion 151a and extends along the arc portion 151a.

The arc portion 151a is formed to be curved when viewed in the width direction W parallel to the rotational axis direction of the photosensitive drum 1. That is, the arc portion 151a is inclined with respect to the second wall portion D.

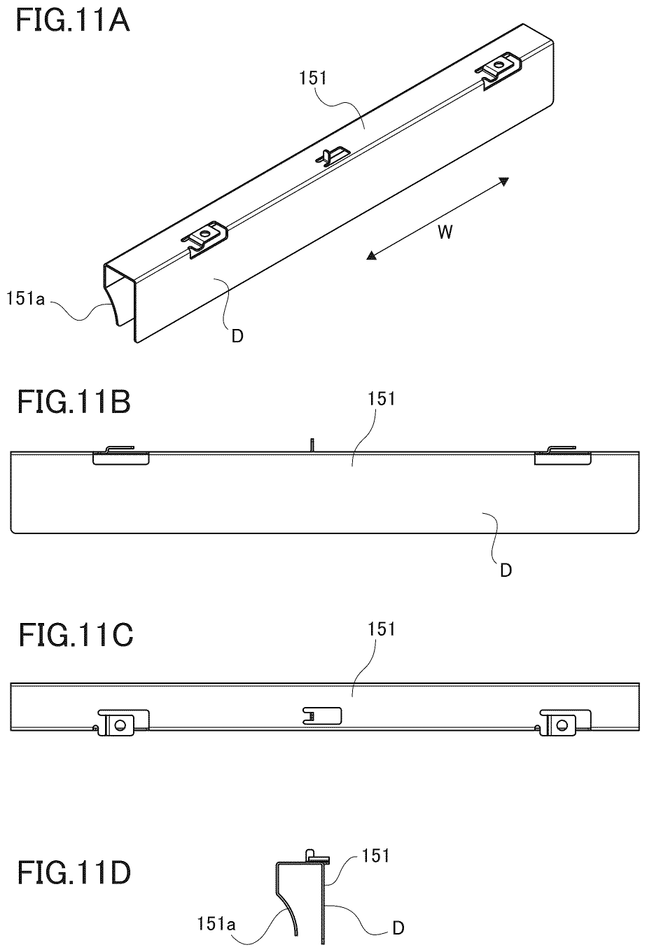

FIG. 11A is a perspective view of the heat exhaust duct 151 according to embodiment 2, and FIG. 11B is a front view of the heat exhaust duct 151. FIG. 11C is a plan view of the heat exhaust duct 151, and FIG. 11D is a side view of the heat exhaust duct 151. The effects according to the present embodiment are similar to those of embodiment 1, and transfer residual toner stored inside the cleaning unit 6 may be suppressed from being aggregated by the heat generated in the fixing device 20, and leakage of transfer residual toner from the cleaning unit 6 may be suppressed. These effects are realized by having the arc portion 151a of the heat exhaust duct 151 arranged adjacent to the arc portion 133a of the fixing cover 133. Thereby, heat conducted to the cleaning unit 6 may be reduced even further by discharging a greater amount of heat of the fixing device 20 while increasing the amount of air flowing through the heat exhaust duct 151.

Secondary effects are also similar to those of embodiment 1, such that the occurrence of fixing failures, such as blister images and cold offsets, caused by the winding of the recording material P or the insufficient fixing temperature according to the state of use of the image forming apparatus A may be suppressed. By arranging the arc portion 151a of the heat exhaust duct 151 adjacent to the arc portion 133a of the fixing cover 133, the effect of reducing the temperature variation of the fixing cover 133 due to the state of use of the image forming apparatus A was realized.

According to these effects, compared to embodiment 1, the amount of air flowing in the heat exhaust duct 151 may be high, such that a greater effect may be achieved, whereas the shape of the heat exhaust duct 151 becomes complex.

As described above, according to the present embodiment, by adopting the heat exhaust duct 151 that corresponds to the shape of the fixing cover 133 that differs from the embodiment 1, effects similar to embodiment 1 may be achieved effectively.

### Embodiment 3

Next, embodiment 3 of the present invention will be described. Embodiment 3 adopts a heat exhaust duct 251 that has a heat discharge efficiency that is further enhanced compared to embodiment 1. Therefore, similar configurations as embodiment 1 are either not shown or denoted with the same reference numbers.

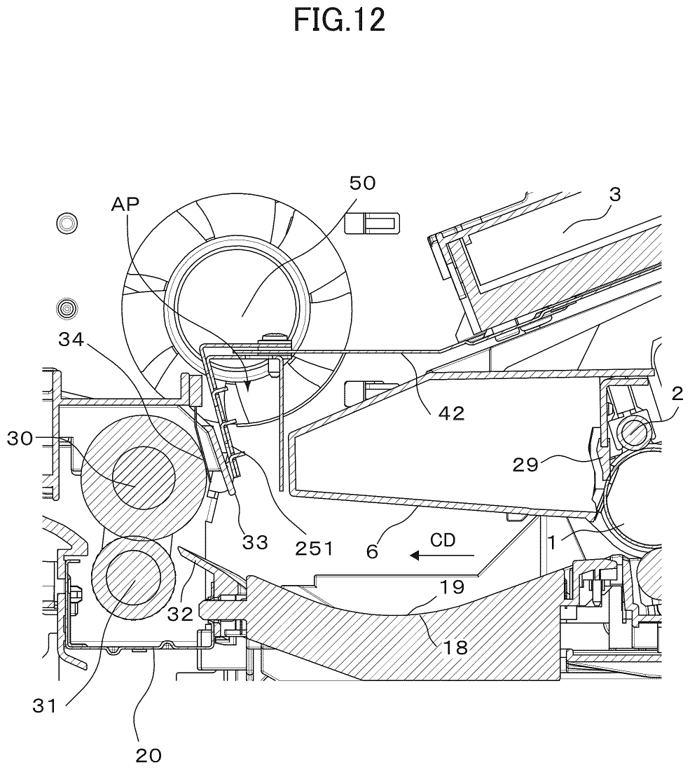

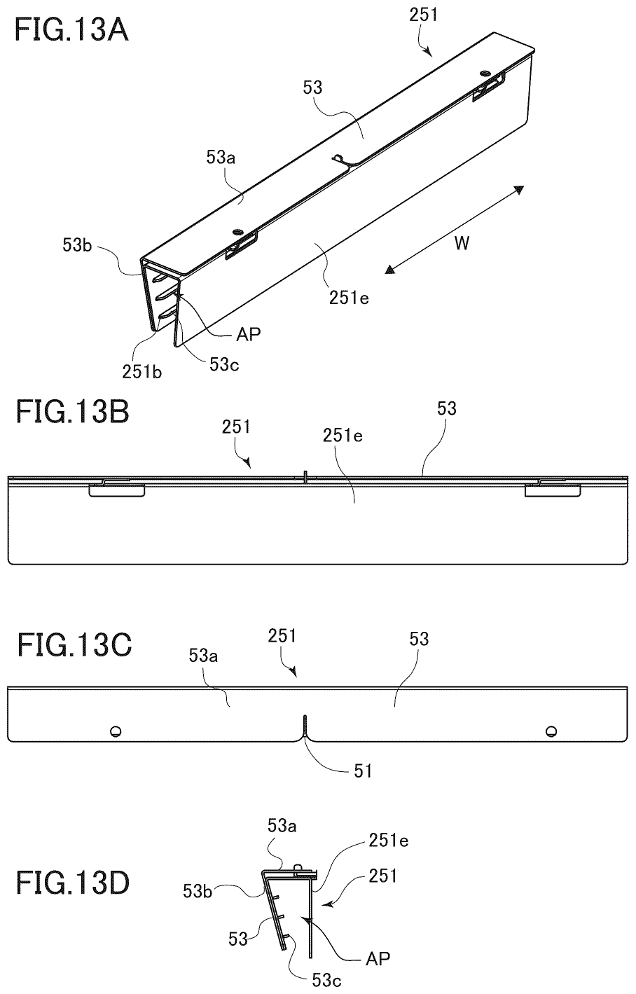

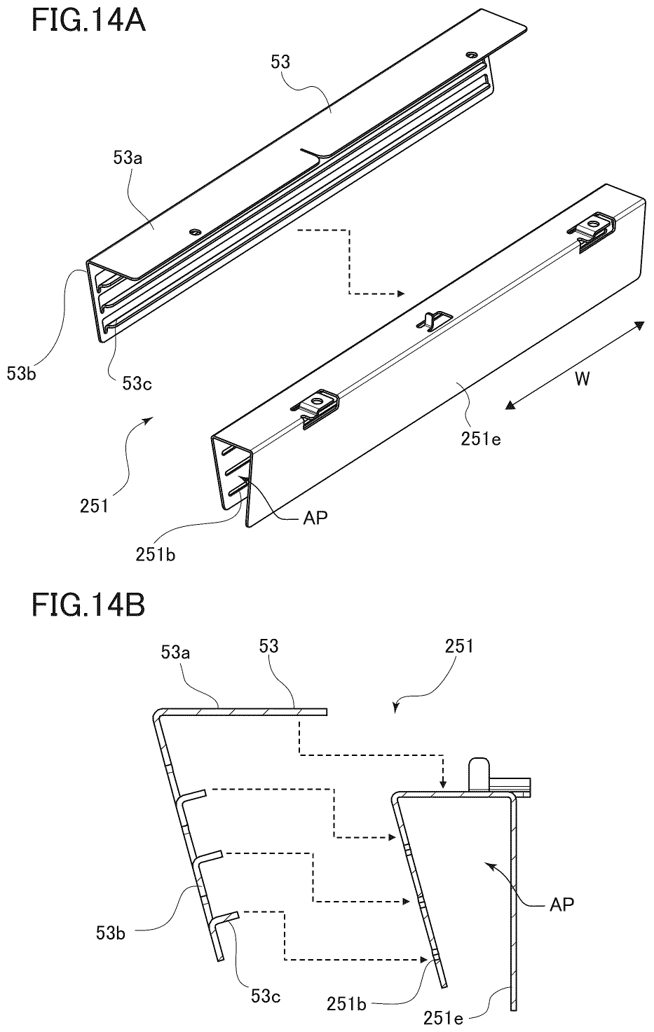

FIG. 12 is a schematic cross-sectional view illustrating a vicinity of the heat exhaust duct 251 according to embodiment 3. FIG. 13A is a perspective view illustrating the heat exhaust duct 251 according to embodiment 3, and FIG. 13b is a front view of the heat exhaust duct 251. FIG. 13C is a plan view of the heat exhaust duct 251, and FIG. 13D is a side view of the heat exhaust duct 251. FIG. 14A is a perspective view illustrating a state in which a heat exhaust fin 53 according to embodiment 3 is assembled to a main body portion 251e of the heat exhaust duct 251, and FIG. 14B is a side view illustrating a state in which the heat exhaust fin 53 is assembled to the main body portion 251e of the heat exhaust duct 251.

As illustrated in FIGS. 13A to 14B, a plurality of, which according to the present embodiment is three, long holes 251b that are extended in the width direction W and aligned in the vertical direction are disposed on the main body portion 251e of the heat exhaust duct 251 serving as a duct. The main body portion 251e serving as a first member has a similar shape as the heat exhaust duct 51 of embodiment 1, excluding the long holes 251b, and forms the air passage AP. The heat exhaust duct 251 is composed by assembling the heat exhaust fin 53 serving as a second member to the main body portion 251e.

The heat exhaust fin 53 is formed of a zinc chromate steel plate, which is a metal material, having an approximately V-shaped cross section, and includes an upper surface 53a, and a side surface 53b that is bent downward and extending from the upper surface 53a. The side surface 53b serving as a first wall portion is opposed to the fixing device 20. A plurality of, which according to the present embodiment is three, projected portions 53c that protrude upstream in the conveyance direction CD are disposed on the side surface 53b. In other words, the plurality of projected portions 53c are protruded toward the air passage AP. Further, the plurality of projected portions 53c extend in a direction intersecting the width direction W, which is a longitudinal direction of the heat exhaust duct 251. The respective projected portions 53c extend in the width direction W so as to correspond to the long holes 251b.

After the main body portion 251e has been attached by sliding toward the thrust direction, i.e., width direction W, on the scanner stay 42 of the main body frame 43, the heat exhaust fin 53 is assembled to the scanner stay 42. In this state, as illustrated in FIG. 12, the main body portion 251e and the heat exhaust fin 53 nip the scanner stay 42. In this state, the main body portion 251e and the heat exhaust fin 53 are fixed to the scanner stay 42 using a fixing screw. In this state, the projected portions 53c of the heat exhaust fin 53 are passed through the long holes 251b and are protruded to the inner side of the heat exhaust duct 251.

The heat exhaust fin 53 achieves an effect of realizing a more efficient heat discharge by widening a surface area of the member that comes into contact with the air flowing through the heat exhaust duct 251. In other words, the plurality of projected portions 53c of the heat exhaust fin 53 have a surface roughness for increasing the surface area of the member that comes into contact with the air passing through the air passage AP within the heat exhaust duct 251. Thereby, the contact area of the heat exhaust duct 251 with air may be increased to enhance the cooling effect. As a result, the heat of the fixing device 20 may be discharged more efficiently, and heat conducted to the cleaning unit 6 may be reduced further.

The effects according to the present embodiment are similar to those of embodiment 1, such that the aggregation of transfer residual toner stored inside the cleaning unit 6 by the heat generated in the fixing device 20 may be suppressed and transfer residual toner may be prevented from leaking from the cleaning unit 6.

The secondary effects are also similar to those of embodiment 1, such that the occurrence of fixing failures, such as blister images and cold offsets, caused by the winding of the recording material P or the insufficient fixing temperature according to the state of use of the image forming apparatus A may be suppressed.

According to these effects, compared to embodiment 1, discharge of heat by air flowing in the heat exhaust duct 251 may be performed more effectively, such that a greater effect may be achieved, whereas the shape of the heat exhaust duct 251 becomes complex since the heat exhaust fin 53 is attached to the main body portion 251e.

As described above, according to the present embodiment, the heat exhaust duct 251 having a higher heat discharge efficiency than embodiment 1 may be provided. In other words, a heat shielding performance from the heat of the fixing device 20 may be improved.

### Embodiment 4

Next, embodiment 4 of the present invention will be described. Embodiment 4 adopts a heat exhaust duct 351 having a heat discharge efficiency that is further enhanced than embodiment 1. Therefore, similar configurations as embodiment 1 are either not shown or denoted with the same reference numbers.

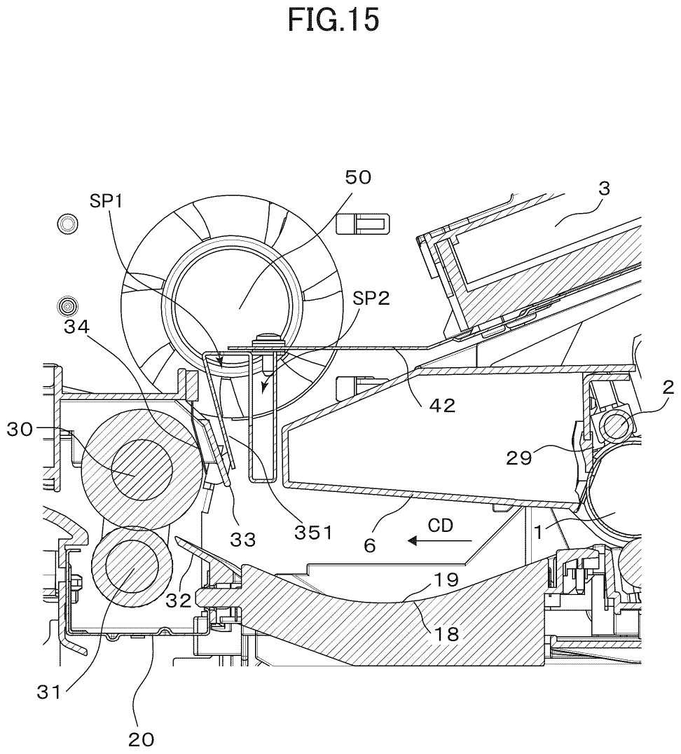

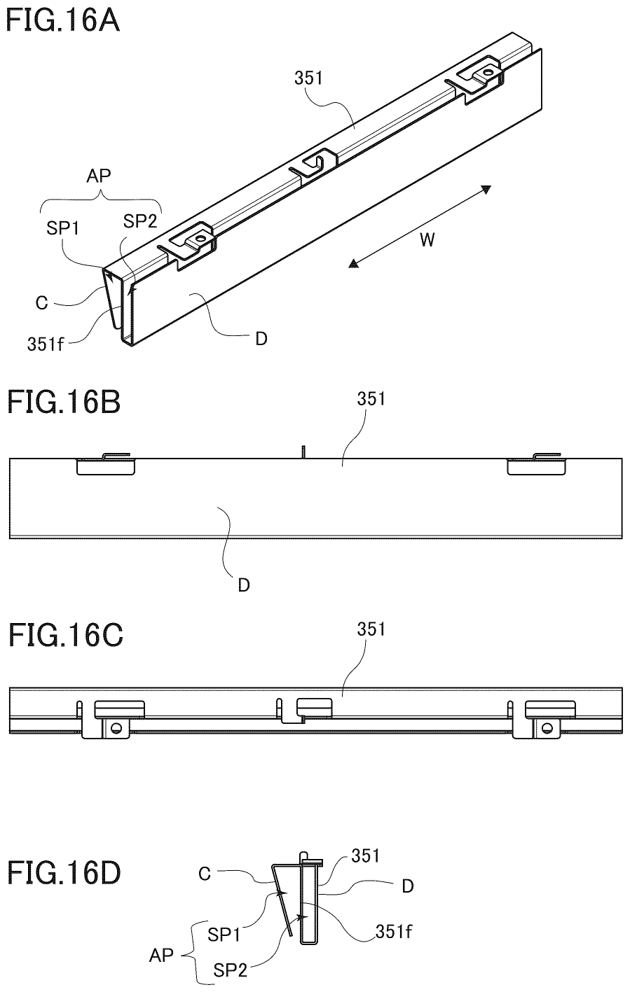

FIG. 15 is a schematic cross-sectional view illustrating a vicinity of the heat exhaust duct 351 according to embodiment 4. FIG. 16A is a perspective view of the heat exhaust duct 351 according to embodiment 4, and FIG. 16B is a front view of the heat exhaust duct 351. FIG. 16C is a plan view of the heat exhaust duct 351, and FIG. 16B is a side view of the heat exhaust duct 351.

The heat exhaust duct 351 serving as a duct includes, as illustrated in FIGS. 15 to 16D, the first wall portion C, the second wall portion D, and a partition wall 351f arranged between the first wall portion C and the second wall portion D. Further, the heat exhaust duct 351 is configured to form two spaces, i.e., air passages, though which air is blown within the heat exhaust duct 351. That is, the heat exhaust duct 351 is bent so as to form a first air passage SP1 on a downstream side in the conveyance direction CD, which is the sheet conveyance direction, that is, close to the fixing device 20, and a second air passage SP2 on an upstream side in the conveyance direction CD, that is, close to the cleaning unit 6. In other words, the partition wall 351f of the heat exhaust duct 351 divides the air passage AP into the first air passage SP1 formed with the first wall portion C and the second air passage SP2 formed with the second wall portion D.

The heat exhaust duct 351 is assembled to the scanner stay 42, and the second air passage SP2 is a space defined by the scanner stay 42 and the heat exhaust duct 351. The air generated by the heat exhaust fan 50 passes through the first air passage SP1 and the second air passage SP2.

By adopting such a configuration, an effect of increasing the temperature difference of the heat exhaust duct 351 by extending the length of the heat exhaust duct 351 from the fixing cover 33 side to the cleaning 6 side may be achieved. Further, by separating the air flowing within the heat exhaust duct 351 into two parts, even if the temperature of the air flowing through the first air passage SP1 close to the fixing cover 33 is increased by heat discharge, the temperature of air flowing through the second air passage SP2 close to the cleaning unit 6 is not easily raised. Thereby, more heat of the fixing device 20 may be discharged, and the heat conducted to the cleaning unit 6 may be further reduced.

The effects of the present embodiment are similar to those of embodiment 1, such that the aggregation of transfer residual toner stored inside the cleaning unit 6 by the heat generated in the fixing device 20 may be suppressed and transfer residual toner may be prevented from leaking from the cleaning unit 6.

The secondary effects are also similar to those of embodiment 1, such that the occurrence of fixing failures, such as blister images and cold offsets, caused by the winding of the recording material P or the insufficient fixing temperature according to the state of use of the image forming apparatus A may be suppressed.

According to these effects, compared to embodiment 1, discharge of heat by air flowing in the heat exhaust duct 351 may be performed more effectively, such that a greater effect may be achieved, whereas the shape of the duct becomes complex since the first air passage SP1 and the second air passage SP2 are formed by the heat exhaust duct 351.

As described above, according to the present embodiment, the heat exhaust duct 351 having a higher heat discharge efficiency than embodiment 1 may be provided. In other words, a heat shielding performance from the heat of the fixing device 20 may be improved.

### Embodiment 5

Next, embodiment 5 of the present invention will be described. Embodiment 5 adopts a different shape of the first wall portion C of the heat exhaust duct 51 according to embodiment 1. Therefore, similar configurations as embodiment 1 are either not shown or denoted with the same reference numbers.

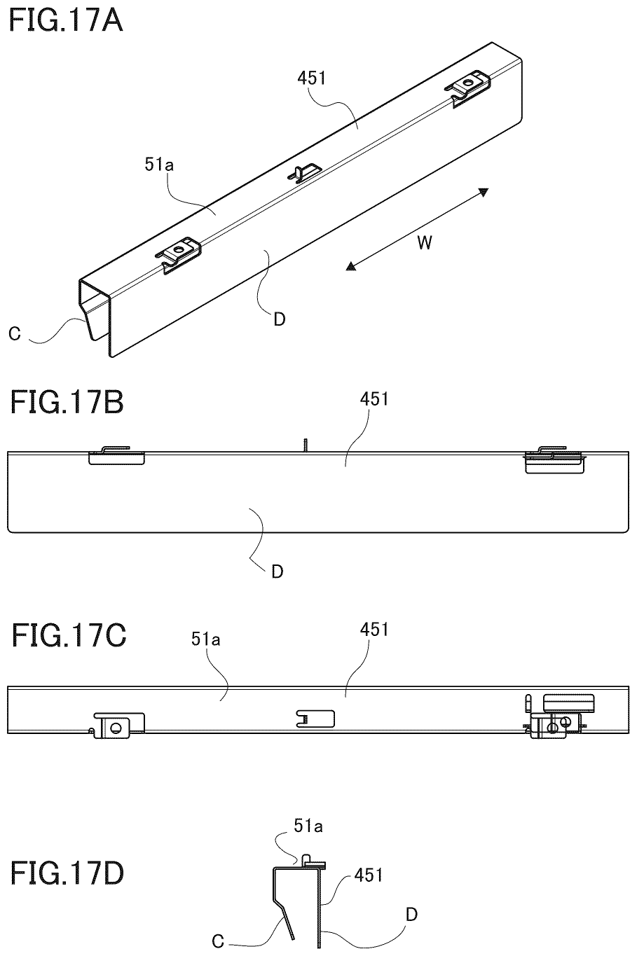

FIG. 17A is a perspective view of a heat exhaust duct 451 according to embodiment 5, and FIG. 17B is a front view of the heat exhaust duct 451. FIG. 17C is a plan view of the heat exhaust duct 451, and FIG. 17D is a side view of the heat exhaust duct 451.

As illustrated in FIGS. 17A to 17D, the first wall portion C of the heat exhaust duct 451 serving as a duct according to embodiment 5 is formed in a bent shape along the shape of the fixing cover 33 illustrated in FIG. 6. That is, the first wall portion C is formed to oppose to the fixing cover 33 and be arranged at a position separated by an approximately even distance from a surface including the planar portion B of the fixing cover 33. Thereby, the amount of air flowing through the heat exhaust duct 451 may be increased, as according to embodiment 2. Therefore, effects similar to embodiments 1 and 2 may be exerted.

### Embodiment 6

Next, embodiment 6 of the present invention will be described. Embodiment 6 includes a projected portion 551b disposed on a heat exhaust duct 551, instead of the heat exhaust fin 53 of embodiment 3. Therefore, similar configurations as embodiment 3 are either not shown or denoted with the same reference numbers.

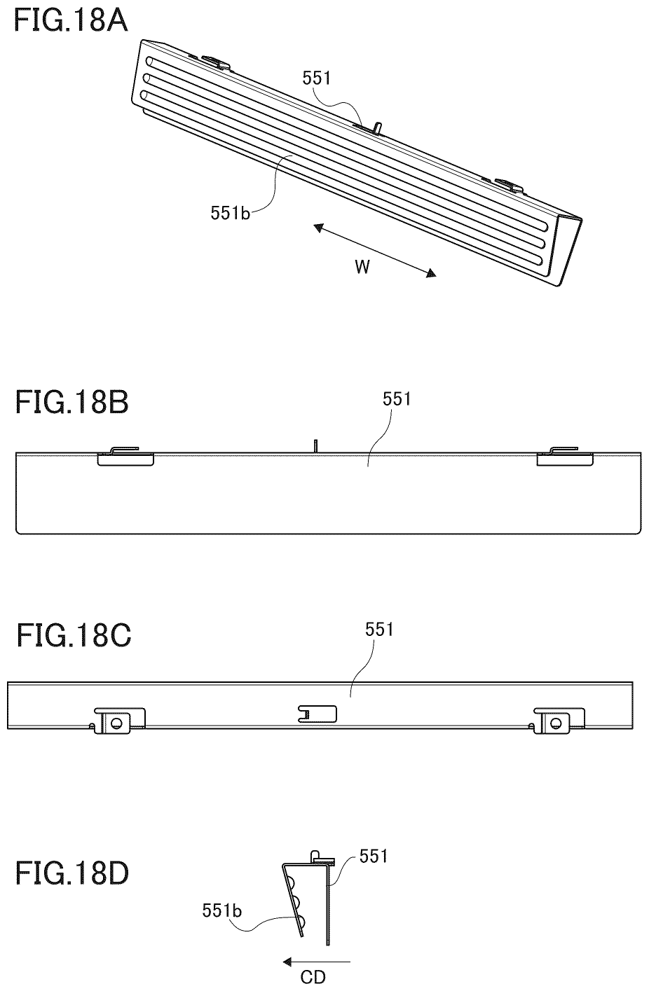

FIG. 18A is a perspective view of the heat exhaust duct 551 according to embodiment 6, and FIG. 18B is a front view of the heat exhaust duct 551. FIG. 18C is a plan view of the heat exhaust duct 551, and FIG. 18D is a side view illustrating the heat exhaust duct 551.

As illustrated in FIGS. 18A to 18D, the heat exhaust duct 551 serving as a duct composed of a metal material is provided with a plurality of, which according to the present embodiment is three, projected portions 551b that protrude toward the heat exhaust duct 551. The projected portions 551b are formed by subjecting a downstream side surface in the conveyance direction CD of the heat exhaust duct 551 to drawing, and they are extended in the width direction W. The projected portions 551b increase the surface area of the member that comes into contact with the air flowing through the heat exhaust duct 551, similar to the heat exhaust fin 53 of embodiment 3. Therefore, effects similar to those of embodiment 3 may be exerted.

### Embodiment 7

Next, embodiment 7 of the present invention will be described. Embodiment 7 includes a heat exhaust fin 653 disposed on an upstream side in the conveyance direction CD of a main body portion 651e, instead of the heat exhaust fin 53 of embodiment 3. Therefore, similar configurations as embodiment 3 are either not shown or denoted with the same reference numbers.

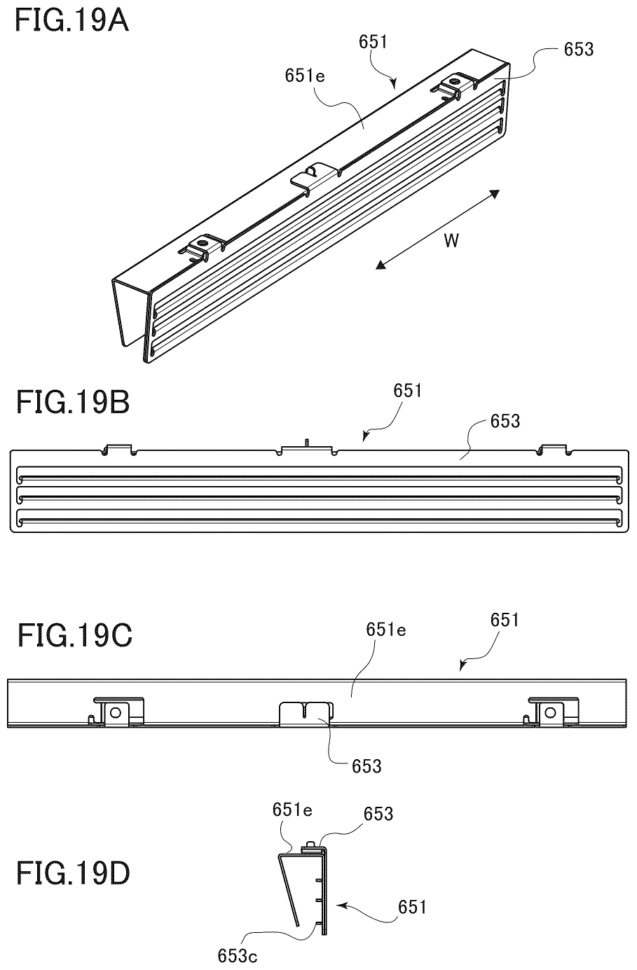

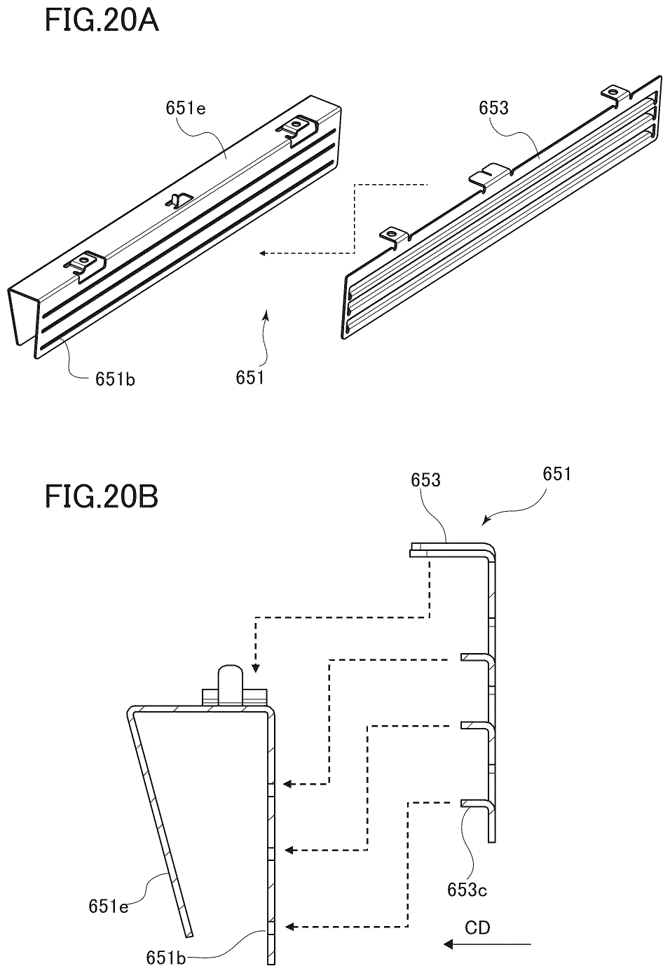

FIG. 19A is a perspective view of a heat exhaust duct 651 according to embodiment 7, and FIG. 19B is a front view of the heat exhaust duct 651. FIG. 19C is a plan view of the heat exhaust duct 651, and FIG. 19D is a side view of the heat exhaust duct 651. FIG. 20A is a perspective view of a state in which the heat exhaust fin 653 according to embodiment 7 is assembled to the main body portion 651e, and FIG. 20B is a side view illustrating a state in which the heat exhaust fin 653 is assembled to the main body portion 651e. By assembling the heat exhaust fin 653 to the main body portion 651e, the heat exhaust duct 651 serving as a duct is formed.

As illustrated in FIGS. 19A to 20B, a plurality of, which according to the present embodiment is three, long holes 651b that are extended in the width direction W and aligned in the vertical direction are disposed on the main body portion 651e of the heat exhaust duct 651. The main body portion 651e serving as a first member has a similar shape as the heat exhaust duct 51 of embodiment 1, excluding the long holes 651b. The heat exhaust fin 653 serving as a second member is composed of a zinc chromate steel plate which is a metal material. A plurality of, which according to the present embodiment is three, projected portions 653c that protrude toward the downstream side in the conveyance direction CD are disposed on the side surface of the heat exhaust fin 653. The respective projected portions 653c are extended in the width direction W in a manner corresponding to the long holes 651b.

The heat exhaust fin 653 is assembled to the scanner stay 42 after the main body portion 651e has been mounted to the scanner stay 42 of the main body frame 43 by sliding in a thrust direction, i.e., the width direction W, as described above. In this state, the heat exhaust fin 653 is attached to the main body portion 651e from an upstream side in the conveyance direction CD. In this state, the projected portions 653c of the heat exhaust fin 653 are passed through the long holes 651b and projected into the inner space of the heat exhaust duct 651.

Similar to embodiments 3 and 6, the heat exhaust fin 653 achieves an effect of realizing a more efficient heat discharge by increasing the surface area of the member that comes into contact with the air flowing in the heat exhaust duct 651. Therefore, the present embodiment exerts a similar effect as embodiments 3 and 6.

According to the present embodiment, the projected portions 653c are disposed on the side of a surface, i.e., second wall portion, of the heat exhaust duct 651 opposed to the cleaning unit 6, whereas according to embodiment 3, the projected portions 53c were disposed on the side of a surface, i.e., first wall portion, of the heat exhaust duct 651 opposed to the fixing device 20. That is, a plurality of projected portions that protrude toward the air passage AP may be disposed on either one of the first wall portion and the second wall portion of the heat exhaust duct.

### Embodiment 8

Next, embodiment 8 of the present invention will be described. Embodiment 8 includes a projected portion 751b disposed on a heat exhaust duct 751 instead of the projected portion 551b of embodiment 6. Therefore, similar configurations as embodiment 6 are either not shown or denoted with the same reference numbers.

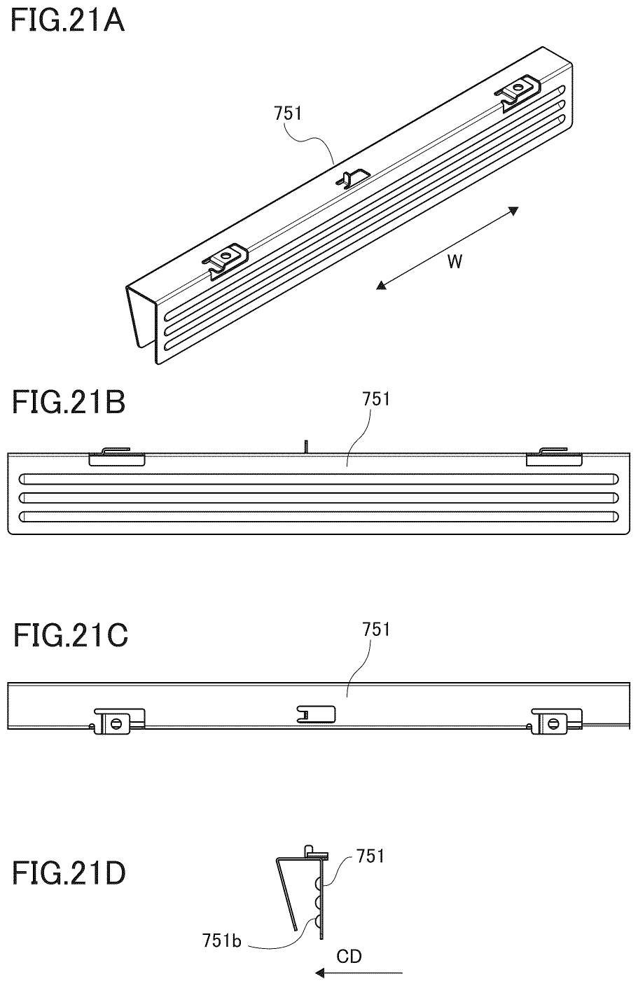

FIG. 21A is a perspective view of the heat exhaust duct 751 according to embodiment 8, and FIG. 21B is a front view of the heat exhaust duct 751. FIG. 21C is a plan view of the heat exhaust duct 751, and FIG. 21D is a side view of the heat exhaust duct 751.

As illustrated in FIGS. 21A to 21D, the heat exhaust duct 751 serving as a duct composed of a metal material is provided with a plurality of, which according to the present embodiment is three, projected portions 751b that protrude toward the inner side space of the heat exhaust duct 751. The projected portions 751b are formed by drawing the surface on the upstream side in the conveyance direction CD of the heat exhaust duct 751, and are extended in the width direction W. The projected portions 751b enable to increase the surface area of the member that comes into contact with the air flowing through the heat exhaust duct 751, similar to the heat exhaust fin 53 of embodiment 3. In other words, the plurality of projected portions 751b of the heat exhaust duct 751 is a surface roughness that is provided to increase the surface area of the member that comes into contact with the air flowing through the air passage AP in the heat exhaust duct 751. Thereby, the contact area of the heat exhaust duct 751 to air may be increased, and the cooling effect may be enhanced. Therefore, effects similar to those of embodiments 3 and 6 may be exerted.

### Embodiment 9

Next, embodiment 9 of the present invention will be described. Embodiment 9 includes a heat exhaust duct 851 composed of two members instead of the heat exhaust duct 351 of embodiment 4. Therefore, similar configurations as embodiment 4 are either not shown or denoted with the same reference numbers.

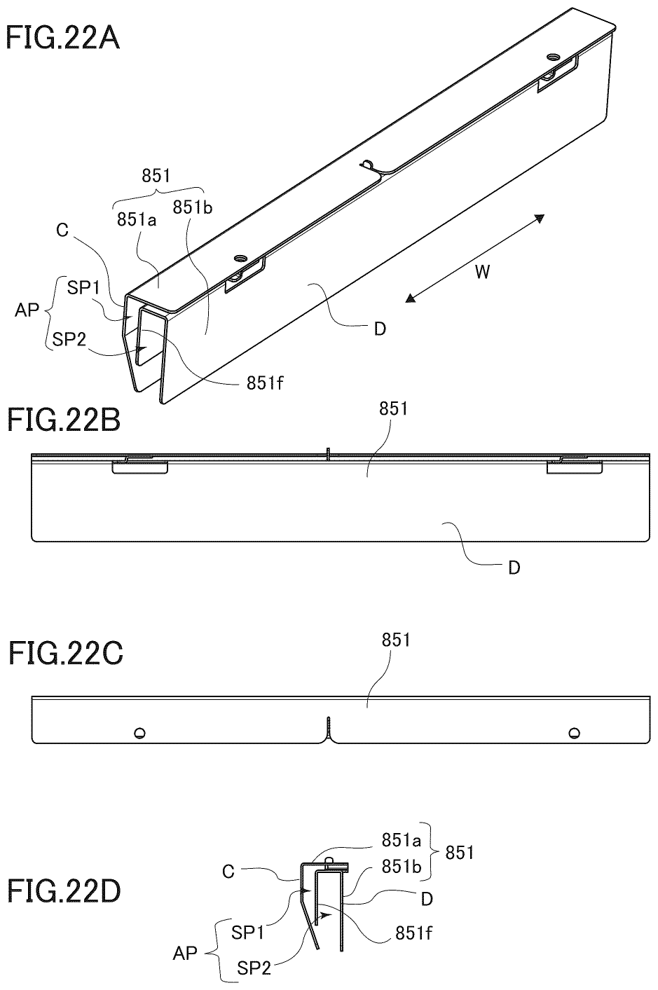

FIG. 22A is a perspective view of the heat exhaust duct 851 according to embodiment 9, and FIG. 22B is a front view of the heat exhaust duct 851. FIG. 22C is a plan view of the heat exhaust duct 851, and FIG. 22D is a side view of the heat exhaust duct 851.

As illustrated in FIGS. 22A to 22D, the heat exhaust duct 851 serving as a duct according to embodiment 9 includes a first member 851a and a second member 851b. The first member 851a and the second member 851b are assembled to each other and fixed integrally by fixing screws. The first member 851a includes the first wall portion C opposed to the fixing device 20. The second member 851b includes the second wall portion D opposed to the cleaning unit 6, and a partition wall 851f.

The heat exhaust duct 851 is formed to define two spaces, i.e., air passages, through which air is flown within the heat exhaust duct 851. That is, the heat exhaust duct 851 is bent so as to form a first air passage SP1 on a downstream side in the conveyance direction CD, that is, close to the fixing device 20, and a second air passage SP2 on an upstream side in the conveyance direction CD, that is, close to the cleaning unit 6. In other words, the partition wall 851f of the second member 851b divides the air passage AP into the first air passage SP1 formed between the first wall portion C and the second air passage SP2 formed between the second wall portion D.

Thereby, even though there is a disadvantage that two members are required, there is an advantage that two spaces through which air may be flown within the heat exhaust duct 851 may be provided in a more airtight manner, that is, with less air escaping from the heat exhaust duct 851. Therefore, effects similar to embodiment 4 may be exerted.

According to embodiments 5 to 9 described above, the heat conducted to the cleaning unit 6 may be reduced further by the air flowing within the heat exhaust duct while discharging more heat from the fixing device 20, such that heat may be discharged efficiently by a small sized configuration. That is, the heat shielding performance of heat from the fixing device 20 may be improved.

### Embodiment 10

Next, embodiment 10 of the present invention will be described. Embodiment 10 is designed to have an improved conveyance performance of the recording material P compared to embodiment 1. Therefore, similar configurations as embodiment 1 are either not shown or denoted with the same reference numbers. Regarding the configuration of the image forming apparatus of embodiment 10, the positional relationships of the heat exhaust duct, the pre-fixing guide 32, and the fixing cover differ from embodiment 1, and the other configurations are similar to embodiment 1. Therefore, configurations that are the same as embodiment 1 are not described.

### Heat Exhaust Duct

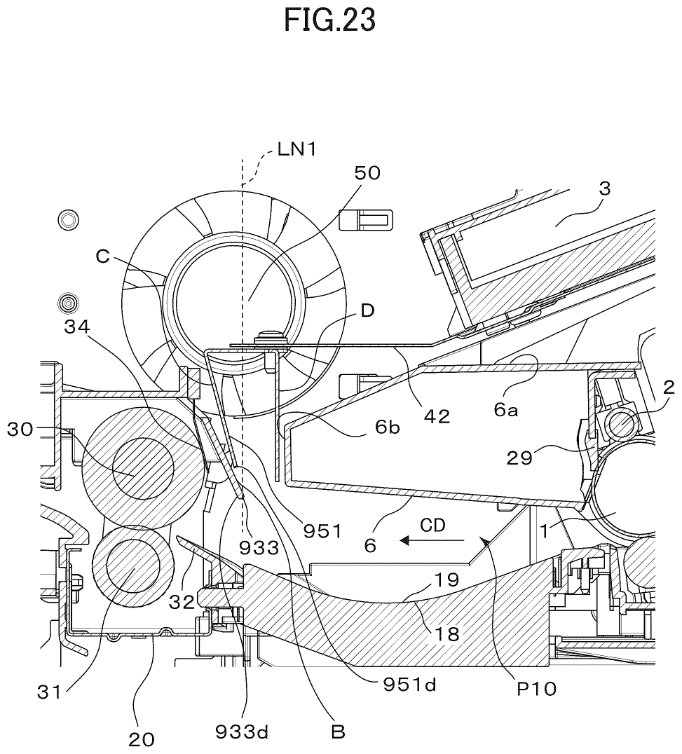

FIG. 23 is a schematic cross-sectional view of a vicinity of a heat exhaust duct 951 according to embodiment 10. In the heat exhaust duct 951 according to the present embodiment, a positional relationship between the first wall portion C of the heat exhaust duct 951 adjacent to the planar portion B of a fixing cover 933 and the planar portion B of the fixing cover 933 differs from embodiment 1.

According to the present embodiment, as illustrated in FIG. 23, the first wall portion C of the heat exhaust duct 951 adjacent to the planar portion B of the fixing cover 933 includes an end portion 951d formed as a free end. Further, the planar portion B of the fixing cover 933 includes an end portion 933d formed as a free end. The end portion 933d is an upstream end of the fixing cover 933 in the conveyance direction CD. The first wall portion C is arranged so as not to cross over a straight line LN1 that passes the end portion 933d and extends in the vertical direction. That is, the end portion 951d of the first wall portion C is arranged downstream in the conveyance direction CD than the straight line LN1.

A distance between the planar portion B of the fixing cover 933 and the first wall portion C of the heat exhaust duct 951 adjacent to the planar portion B of the fixing cover 933 is 3.0 mm or smaller. More specifically, a distance between the planar portion B and the first wall portion C at a nearest portion is 1.0 mm, and a distance therebetween at a farthest portion is 2.5 mm. Further, by arranging the heat exhaust duct 951 formed of a metal plate at a boundary between the fixing device 20 and the cleaning unit 6, the heat of the fixing device 20 is suppressed from being conducted directly to the cleaning unit 6. A distance between the second wall portion D of the heat exhaust duct 951 adjacent to the surface 6b of the container 6a of the cleaning unit 6 and the surface 6b is 2.0 mm.

### Effects of Embodiment 10

The effects of the present embodiment will now be described. According to the present embodiment, the first wall portion C of the heat exhaust duct 951 is arranged so as not to cross over a straight line LN1 that passes the end portion 933d of the planar portion B. That is, the planar portion B of the fixing cover 933 extends directly below the end portion 951d of the first wall portion C of the heat exhaust duct 951. In other words, the planar portion B of the fixing cover 933 is interposed between the conveyance path P10 formed between the transfer nip portion and the fixing nip portion and the end portion 951d of the first wall portion C of the heat exhaust duct 951, wherein the end portion 951d is not directly opposed to the conveyance path P10. The fixing cover 933 is composed of a resin material having superior electric insulation property, such as polycarbonate. Thereby, a stable conveyance performance of the recording material P may be achieved without the recording material P being influenced by the electrostatic attraction force that acts on the heat exhaust duct 951 serving as a duct and experiencing defects such as wrinkling of paper.

This is related to the recording material P being supplied of charge from the transfer roller 5 when passing through the transfer roller 5 and being charged thereby. When a grounded object is brought close to the recording material P being charged, electrostatic attraction force acts on the object from the recording material P. However, even if the heat exhaust duct 951 is grounded to the main body frame 43 via the scanner stay 42 as according to the present embodiment, by arranging the first wall portion C of the heat exhaust duct 951 so as not to cross over the straight line LN1, an effect of suppressing electrostatic attraction force from acting on the heat exhaust duct 951 from the recording material P may be achieved.

### Confirmation of Effect of Embodiment 10

Next, the results of a conveyance performance experiment of the recording material P will be described to confirm the effects of the present embodiment. The heat exhaust duct 951 according to the present embodiment and the heat exhaust duct 51 according to embodiment 1 as a comparative example are used to confirm the effects.

The methods of the conveyance performance experiment of the recording material P will be described. A CS-068 standard paper (product name, Canon Marketing Japan) having a grammage of 68 g/m2 and a sheet size of A4 was used as the recording material.

According to the image forming apparatus used for the experiment, a processing speed during the experiment was 280 mm/sec, and the throughput thereof was 50 images per minute. The set temperature of the fixing device was 200° C. As for the atmospheric environment in which the experiment was performed, the temperature was 15° C. and the humidity was 10%.

After leaving the image forming apparatus and the recording material P for two nights in the above-mentioned atmospheric environment, printing was performed by simplex continuous printing to 200 sheets of recording material continuously, and the occurrence of wrinkling of the paper was confirmed.

The results obtained by the conveyance performance experiment of the recording material P are shown in Table 4.

TABLE 4

| | OCCURRENCE OF PAPER WRINKLING |
|---|---|
| EMBODIMENT 10 | 0/200 |
| EMBODIMENT 1 | 18/200 |

In a case where the heat exhaust duct 951 according to the present embodiment was used, wrinkling of paper of the recording material P did not occur, and good results were achieved. Meanwhile, when the heat exhaust duct 951 of embodiment 1 was used, wrinkling of paper of the recording material P occurred as a result. That is, by adopting the heat exhaust duct 951 of the present embodiment, conveyance performance of the recording material P was improved, and the occurrence of wrinkling of paper was suppressed.

As described above, by arranging the first wall portion C of the heat exhaust duct 951 so as not to cross over the straight line LN1, the influence of electrostatic attraction force of the recording material P acting on the heat exhaust duct 951 may be suppressed. Thereby, conveyance failures such as wrinkling of paper may be suppressed and conveyance performance may be improved while enhancing the heat shielding performance of the heat from the fixing device 20.

### Embodiment 11

Next, embodiment 11 of the present invention will be described. Embodiment 11 has changed the shapes of the fixing cover 933 and the heat exhaust duct 951 of embodiment 10. Therefore, configurations that are similar to embodiment 3 are either not described or denoted Heat Exhaust Duct and Fixing Cover

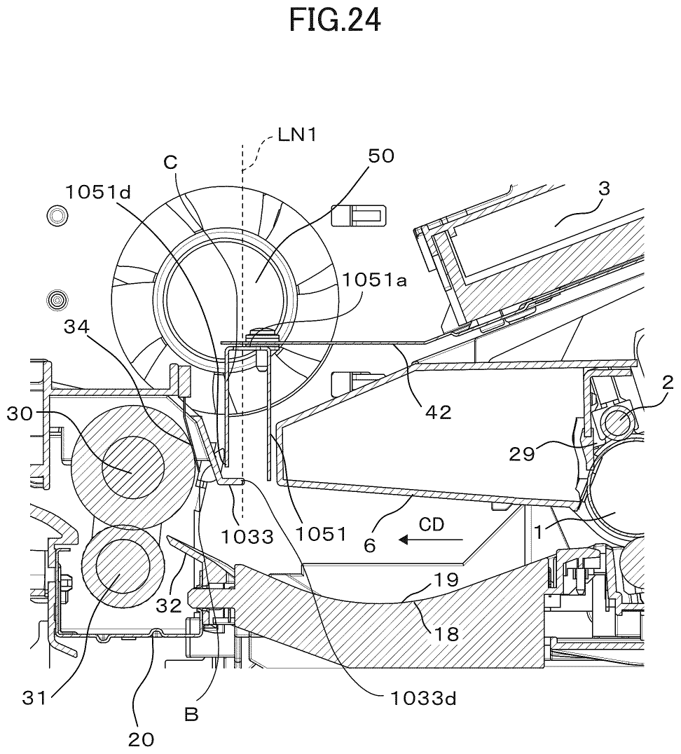

FIG. 24 is a schematic cross-sectional view of a vicinity of a heat exhaust duct 1051 according to embodiment 11. As illustrated in FIG. 24, an angle formed by the first wall portion C and an upper surface 1051a of the heat exhaust duct 1051 is 90°. The planar portion B of a fixing cover 1033 according to the present embodiment is bent, and a vicinity of an end portion 1033d extends upstream in the conveyance direction CD. In other words, the planar portion B is arranged to cover an end portion 1051d of the first wall portion C of the heat exhaust duct 1051 that serves as a duct. The fixing cover 1033 is formed of a resin material having superior electric insulation property, such as polycarbonate. Even according to the configuration of the present embodiment, the influence of electrostatic attraction force that acts on the heat exhaust duct 1051 from the recording material P may be suppressed. Thereby, the conveyance failure such as wrinkling of paper may be suppressed and the conveyance performance may be improved while enhancing the heat shielding performance of heat from the fixing device 20.

### Embodiment 12

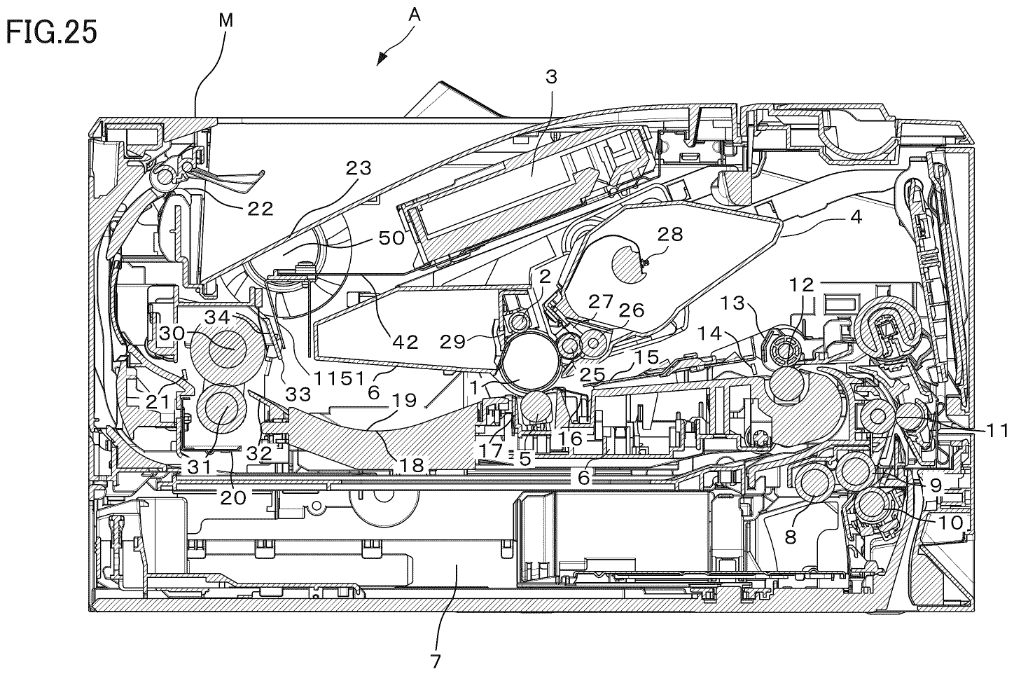

Next, embodiment 12 of the present invention will be described. Embodiment 12 has suppressed the rising of temperature of the exposing unit 3 compared to embodiment 1. Therefore, similar configurations as embodiment 1 are either not shown or denoted with the same reference numbers. FIG. 25 is a schematic cross-sectional view of the image forming apparatus A according to embodiment 12.

As illustrated in FIG. 25, the scanner stay 42 supports the exposing unit 3 that irradiates laser light to the photosensitive drum 1. Further, a heat exhaust duct 1151 serving as a duct may be mounted to the scanner stay 42 by sliding in a thrust direction, i.e., the width direction W. That is, exhaust heat of the fixing device 20 taken into the heat exhaust duct 1151 may be flown through the scanner stay 42 toward the exposing unit 3. In that case, the temperature of the exposing unit 3 may rise, which may cause abnormal exposing operations, such as the accuracy of the exposed image not meeting standards.

The scanner stay 42 according to the present embodiment is one portion of the main body frame 43, and it is formed of a metal material such as a zinc chromate steel plate to realize a high stiffness. As described, in a case where the scanner stay 42 is composed of a metal material having a higher thermal conductivity than resin, the heat quantity conducted from the heat exhaust duct 1151 to the exposing unit 3 is also increased.

### Heat Exhaust Duct

The heat exhaust duct 1151 according to the present embodiment characterizes in that the heat conducted through the scanner stay 42 is suppressed when discharging the exhaust heat of the fixing device 20 to the exterior. The heat exhaust duct 1151 according to the present embodiment is attached to the scanner stay 42 in a state where a heat insulating member 55 is inserted between the heat exhaust duct 1151 and the scanner stay 42.

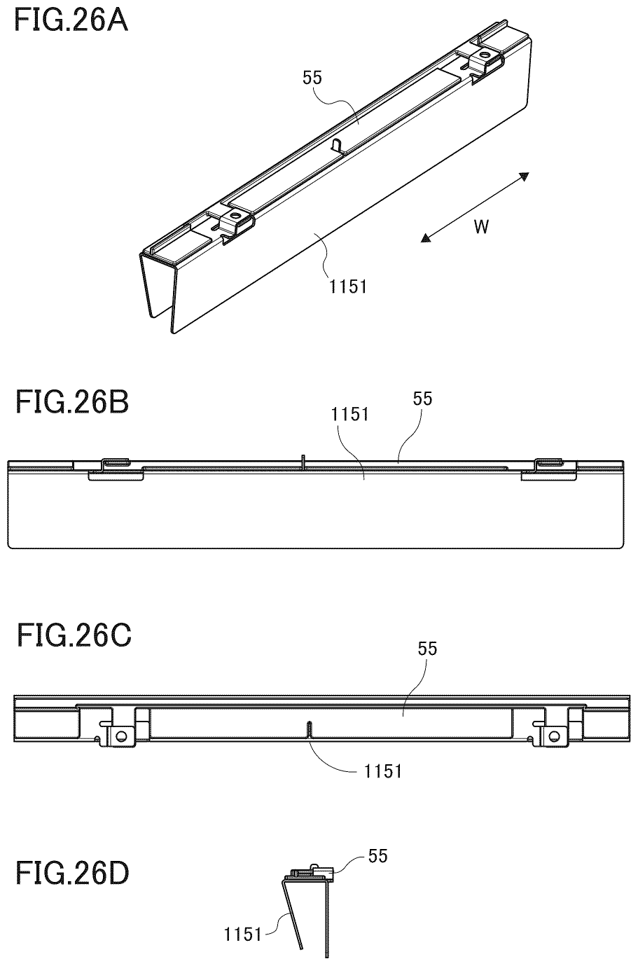

FIG. 26A is a perspective view of the heat exhaust duct 1151 according to embodiment 12, and FIG. 26B is a front view of the heat exhaust duct 1151. FIG. 26C is a plan view of the heat exhaust duct 1151, and FIG. 26D is a side view of the heat exhaust duct 1151.

As illustrated in FIGS. 26A to 26D, the heat insulating member 55 according to the present embodiment adopts a polycarbonate having a relatively low thermal conductivity, and it is attached to the heat exhaust duct 1151 using double-sided tape. The heat insulating member 55 has lower thermal conductivity than the heat exhaust duct 1151 formed of a metal material. The polycarbonate is a kind of resin material, and the heat insulating member 55 may be composed of a resin material other than polycarbonate. The heat insulating member 55 extends in the width direction W, and the length thereof is preferably long in the width direction W, as long as the mounting of the heat exhaust duct 1151 on the scanner stay 42 is not obstructed. In the present embodiment, NS5000 (product name, Nitto Denko Corporation) was used as the double-sided tape. The heat exhaust duct 1151 having the heat insulating member 55 attached thereto is mounted to the scanner stay 42 using a screw.

### Effects of Embodiment 12

The effects of the present embodiment will be described. By arranging the heat insulating member 55 between the heat exhaust duct 1151 and the scanner stay 42 as according to the present embodiment, thermal conduction from the heat exhaust duct 1151 to the scanner stay 42 may be suppressed.

The effect of suppressing temperature rise of the exposing unit 3 may also be achieved by arranging a heat insulating member between the scanner stay 42 and the exposing unit 3. However, when the temperature of the scanner stay 42 rises, the ambient temperature near the exposing unit 3 rises, by which the rising of temperature of the exposing unit 3 may be caused. Therefore, the configuration as according to the present embodiment of suppressing thermal conduction from the heat exhaust duct 1151 to the scanner stay 42 has a higher effect of suppressing temperature rise of the exposing unit 3.

### Confirmation of Effects of Embodiment 12

Next, the results of a temperature rise experiment of the exposing unit 3 will be described to confirm the effects of the present embodiment. The heat exhaust duct 1151 according to the present embodiment and the heat exhaust duct 51 according to embodiment 1 as a comparative example have been used to confirm the effects.

The methods of the temperature rise experiment will be described. A Canon Red Label (product name, Canon E.U.) having a grammage of 80 g/m2 and a sheet size of A4 was used as the recording material. According to the image forming apparatus used for the experiment, a processing speed during the experiment was 280 mm/sec, and the throughput thereof was 50 images per minute. The set temperature of the fixing device 20 was 200° C. As for the atmospheric environment in which the experiment was performed, the temperature was 32.5° C. and the humidity was 80%.

After leaving the image forming apparatus A in a power OFF state for one night and confirming that the temperature inside the apparatus is sufficiently close to the atmospheric environment, a lateral line image with an image coverage of 2% was printed by duplex continuous printing to 500 sheets, i.e., 1,000 images, and thereafter, the surface temperature of the scanner stay 42 and the surface temperature of the exposing unit 3 were confirmed. A thermocouple was made to come into contact with the mounting portion for attaching the exposing unit 3 of the scanner stay 42 and the polygon motor portion of the exposing unit 3 to measure the highest temperatures that have been reached respectively.

The result of the temperatures measured by the temperature rise experiment are shown in Table 5.

TABLE 5

| | SURFACE | SURFACE |
|---|---|---|
| | TEMPERATURE | TEMPERATURE |
| | OF SCANNER | OF EXPOSING |
| | STAY | UNIT |
| HEAT EXHAUST DUCT | 40° C. | 55° C. |
| OF EMBODIMENT 12 | | |
| HEAT EXHAUST DUCT | 45° C. | 60° C. |
| OF EMBODIMENT 1 | | |

When the heat exhaust duct 1151 according to the present embodiment was used, the surface temperature of the scanner stay 42 was 40° C. and the surface temperature of the exposing unit 3 was 55° C. Meanwhile, when the heat exhaust duct 51 of embodiment 1 was used, the surface temperature of the scanner stay 42 was 45° C. and the surface temperature of the exposing unit 3 was 60° C. That is, by adopting the heat exhaust duct 1151 according to the present embodiment, the temperature rise of the scanner stay 42 may be suppressed, and the temperature rise of the exposing unit 3 may also be suppressed.

As described, by arranging the heat insulating member 55 between the heat exhaust duct 1151 and the scanner stay 42, the thermal conduction from the heat exhaust duct 1151 to the scanner stay 42 may be suppressed, and the rising of temperature of the exposing unit 3 may be suppressed. In other words, the heat shielding performance of the heat from the fixing device 20 may be enhanced.

### Embodiment 13

Next, embodiment 13 of the present invention will be described. Embodiment 13 has suppressed the rising of temperature of the exposing unit 3 with a simpler configuration compared to embodiment 12. Therefore, similar configurations as embodiment 12 are either not shown or denoted with the same reference numbers.

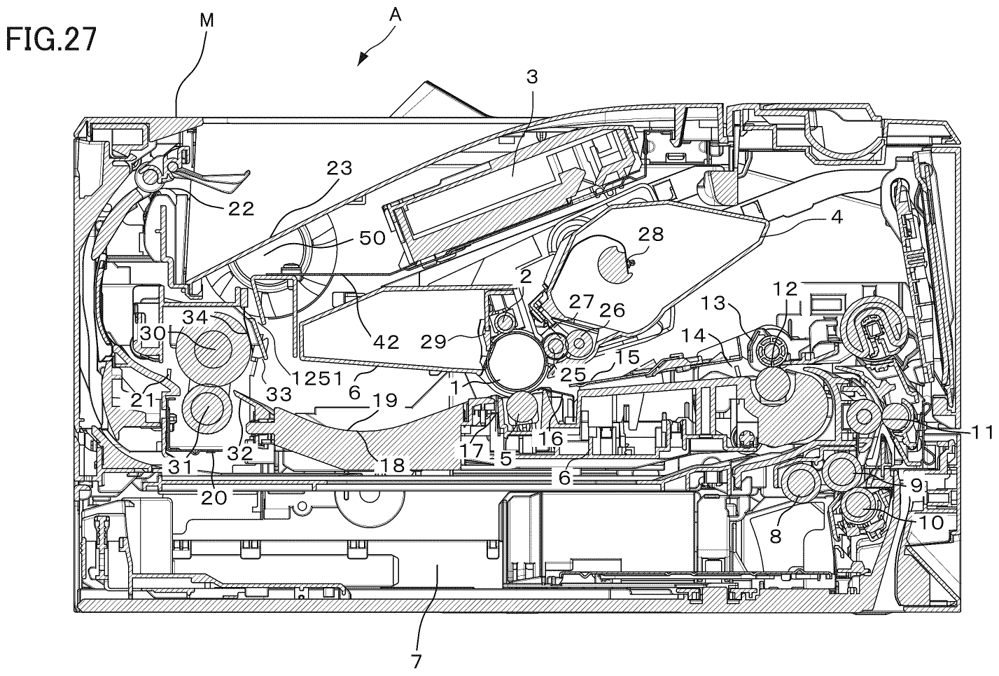

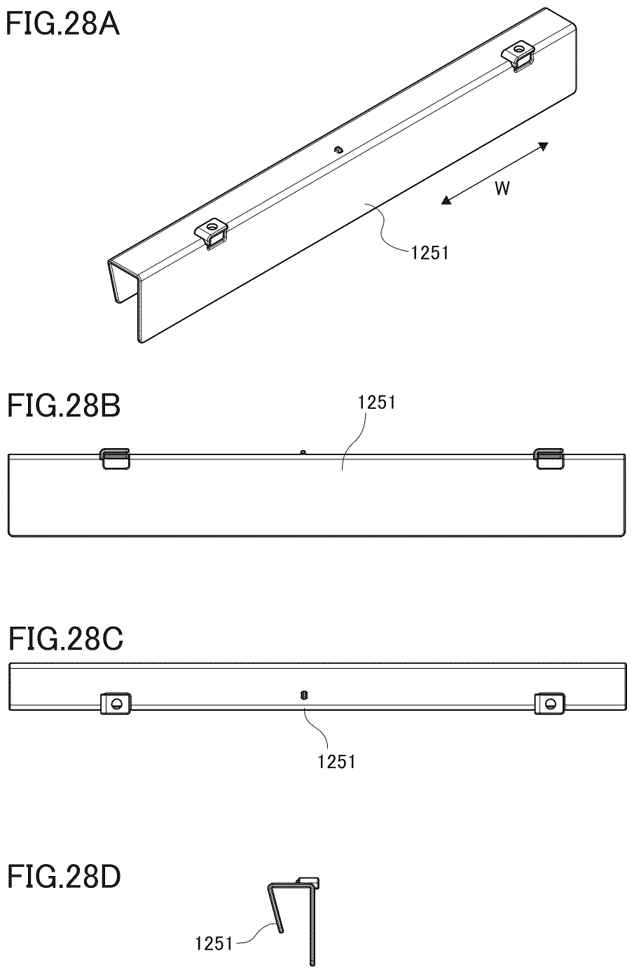

FIG. 27 is a schematic cross-sectional view of the image forming apparatus A according to embodiment 13. As illustrated in FIG. 27, a heat exhaust duct 1251 according to the present embodiment characterizes in being formed of a resin material having a lower thermal conductivity than a metal material. FIG. 28A is a perspective view of the heat exhaust duct 1251 according to embodiment 13, and FIG. 28B is a front view of the heat exhaust duct 1251. FIG. 28C is a plan view of the heat exhaust duct 1251, and FIG. 28D is a side view of the heat exhaust duct 1251. The shape of the heat exhaust duct 1251 may be any of the shapes described in the aforementioned embodiments.

In embodiment 12 described above, the heat exhaust duct 1251 and the scanner stay 42 are composed of a metal material having a high thermal conductivity. Therefore, by disposing the heat insulating member 55 having a low thermal conductivity between the heat exhaust duct 1251 and the scanner stay 42, the thermal conduction from the heat exhaust duct 1251 to the scanner stay 42 was suppressed, and the rising of temperature of the exposing unit 3 was thereby suppressed.

According to the present embodiment, the heat exhaust duct 1251 is formed of a resin material having a lower thermal conductivity than the scanner stay 42 formed of a metal material. Thereby, the temperature rise of the exposing unit 3 may be suppressed. However, since the heat exhaust duct 1251 is formed of a resin material, the effect of absorbing the heat of the fixing device 20 with the heat exhaust duct 1251 and discharging the heat by the air flowing through the duct is somewhat reduced. Further, the scanner stay 42 forms a part of the main body frame 43, and in order to ensure a high stiffness, it is preferable to form the heat exhaust duct 1251 with a metal material such as a zinc chromate steel plate.

As described above, according to the present embodiment, the heat exhaust duct 1251 serving as a duct is formed of a material having a low thermal conductivity, such that the temperature rise of the exposing unit 3 may be suppressed. Thereby, the temperature rise of the exposing unit 3 may be suppressed by a simple configuration without having to arrange the heat insulating member 55 between the heat exhaust duct 1251 and the scanner stay 42. In other words, the heat shielding performance of the heat from the fixing device 20 may be enhanced.

If it is possible to ensure stiffness, the scanner stay 42 may be formed of a resin material having a low thermal conductivity, or the heat exhaust duct 1251 and the scanner stay 42 may be formed of a resin material having a low thermal conductivity.

### Embodiment 14

Next, embodiment 14 of the present invention will be described. Embodiment 14 is designed to take in exhaust heat of the fixing device 20 more efficiently compared to embodiment 1. Therefore, similar configurations as embodiment 1 are either not shown or denoted with the same reference numbers.

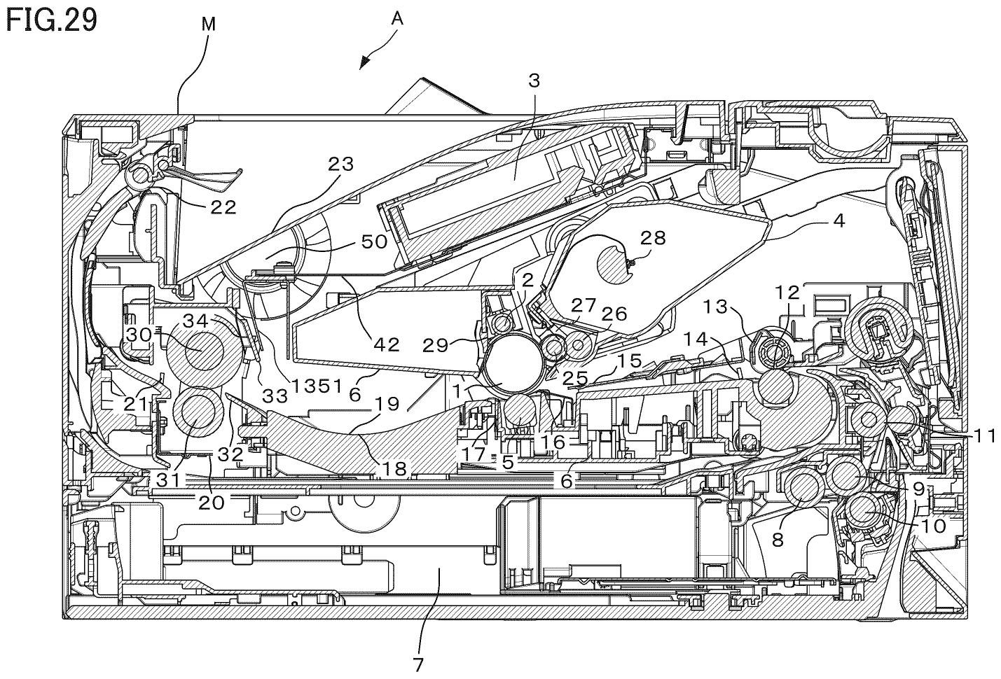

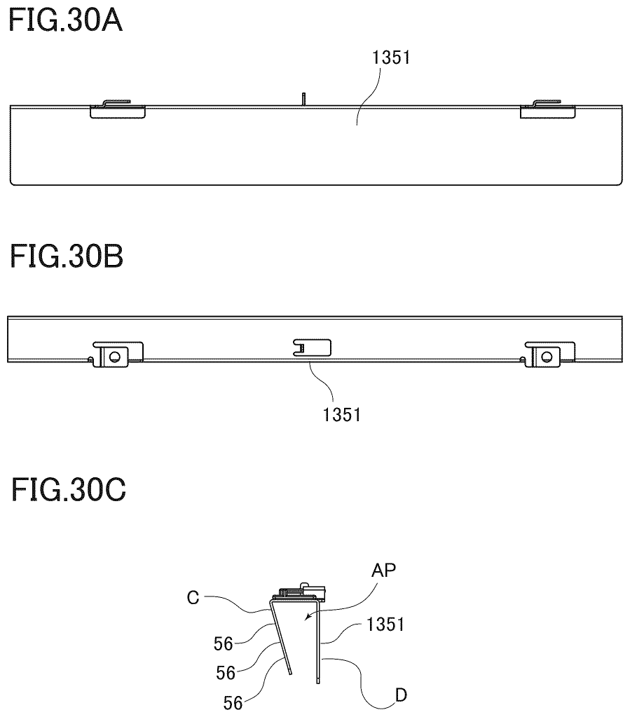

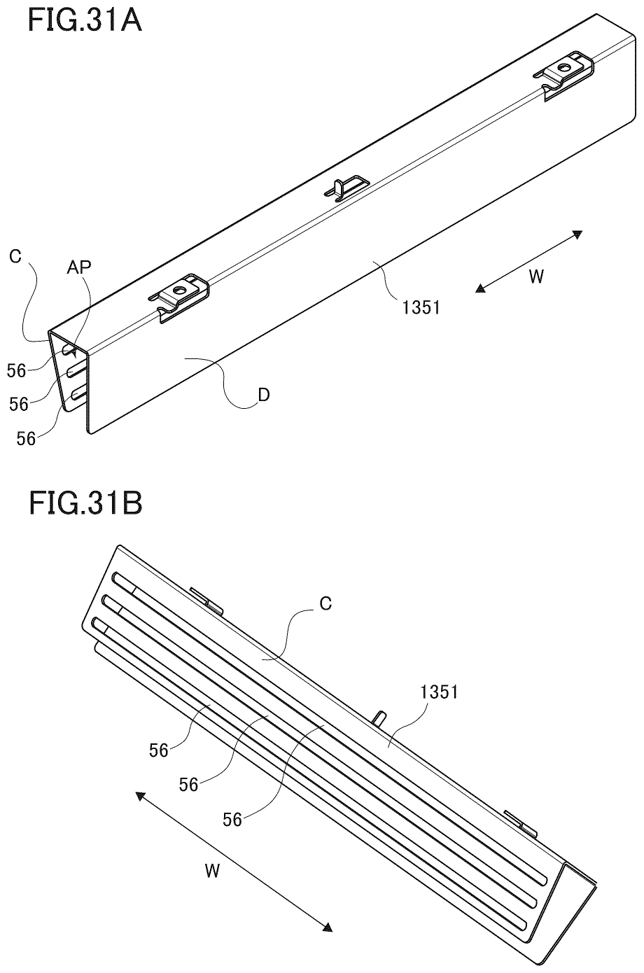

FIG. 29 is a schematic cross-sectional view of a vicinity of a heat exhaust duct 1351 according to embodiment 14. FIG. 30A is a front view of the heat exhaust duct 1351 according to embodiment 14, FIG. 30B is a plan view of the heat exhaust duct 1351, and FIG. 30C is a side view of the heat exhaust duct 1351. FIG. 31A is a perspective view of the heat exhaust duct 1351 according to embodiment 14, and FIG. 31B is another perspective view of the heat exhaust duct 1351.

As illustrated in FIGS. 29 to 31B, a plurality of, which according to the present embodiment is three, duct vent holes 56 are formed on the first wall portion C of the heat exhaust duct 1351 serving as the duct facing the fixing cover 33. The duct vent holes 56 serving as a plurality of opening portions are extended in the width direction W, arranged in parallel in the vertical direction, and communicated with the air passage AP. The exhaust heat from the fixing device 20 may be taken in efficiently to the heat exhaust duct 1351 through the duct vent holes 56, and exhaust heat of the fixing device 20 may be discharged efficiently to the exterior of the apparatus.

As for the size of the opening of the duct vent holes 56 disposed on the first wall portion C of the heat exhaust duct 1351, the area ratio of the duct vent holes 56 to the first wall portion Cis 19%. From the viewpoint of achieving the effects of the present embodiment, it is preferable for the area ratio of the duct vent holes 56 to be 3% or higher. The greater the area ratio of the duct vent holes 56, the greater the effect of discharging the exhaust heat from the fixing device 20 to the exterior of the apparatus efficiently.

As a result, by discharging the exhaust heat from the fixing device 20 to the exterior of the apparatus efficiently, the rising of temperature inside the apparatus may be suppressed. In other words, by suppressing the temperature rise of the interior of the apparatus, the temperature rise of the cleaning unit 6 and the exposing unit 3 may be suppressed.

Further, it becomes possible to increase margins related to defects that are generated when the temperature of the heating roller 30 is high or defects that are generated when the temperature thereof is low due to the detected temperature of the thermistor 34 for realizing optimal fixing of toner image to the recording material P being varied between the state where the fixing cover 33 is cooled and where the fixing cover 33 is heated as described in embodiment 1.

While the heat exhaust from the fixing device 20 is increased, the discharge of generated heat from the low voltage power supply 45 through the vent hole 52 and the heat exhaust duct 1351 by air discharge using the heat exhaust fan 50 is reduced. Therefore, the size of the duct vent holes 56 is preferably determined such that the area ratio thereof with respect to the first wall portion C is less than 60%. Regarding the opening ratio, the size of the duct vent holes 56, that is, the opening ratio of the first wall portion C, is to be adjusted according to the characteristics of the image forming apparatus, such as the level of heat exhaust from the fixing device 20 as described above.

As described above, by forming the duct vent holes 56 on the heat exhaust duct 1351, the exhaust heat of the fixing device 20 may be taken in more efficiently to the heat exhaust duct 1351, and the temperature rise of the cleaning unit 6 and the exposing unit 3 may be suppressed. In other words, the heat shielding performance of the heat from the fixing device 20 may be improved.

According to the present embodiment, the duct vent holes 56 serving as the plurality of opening portions are disposed only on the first wall portion C, but the present technique is not limited thereto. For example, the duct vent holes 56 may be disposed on the second wall portion D, or may be disposed on both the first wall portion C and the second wall portion D. That is, the duct vent holes 56 are to be disposed on at least either one of the first wall portion C and the second wall portion D.

### Embodiment 15

Next, embodiment 15 of the present invention will be described. Embodiment 15 is designed to suppress temperature rise of the cleaning unit 6 compared to embodiment 1. Therefore, similar configurations as embodiment 1 are either not shown or denoted with the same reference numbers.

In a case where the print speed is raised compared to the image forming apparatus of embodiment 1, the heat generation quantity of the fixing device 20 is increased, and the cleaning unit 6 that is arranged close to the fixing device 20 and that generates heat by friction with the photosensitive drum 1 is easily heated.

### Heat Exhaust Duct

A heat exhaust duct 1451 serving as a duct according to the present embodiment characterizes in suppressing the heat flowing to the cleaning unit 6 when discharging the exhaust heat from the fixing device 20 to the exterior of the apparatus. Similar to embodiment 1, the heat exhaust duct 1451 according to the present embodiment forms an air passage that is communicated from the electronic component side to the drive side, and efficiently suppresses the exhaust heat of the fixing device 20 from being conducted to the cleaning unit 6. Further, a heat insulating member 155 is disposed on the second wall portion D of the heat exhaust duct 1451 adjacent to the cleaning unit 6, by which conduction of heat to the cleaning unit 6 may be suppressed.

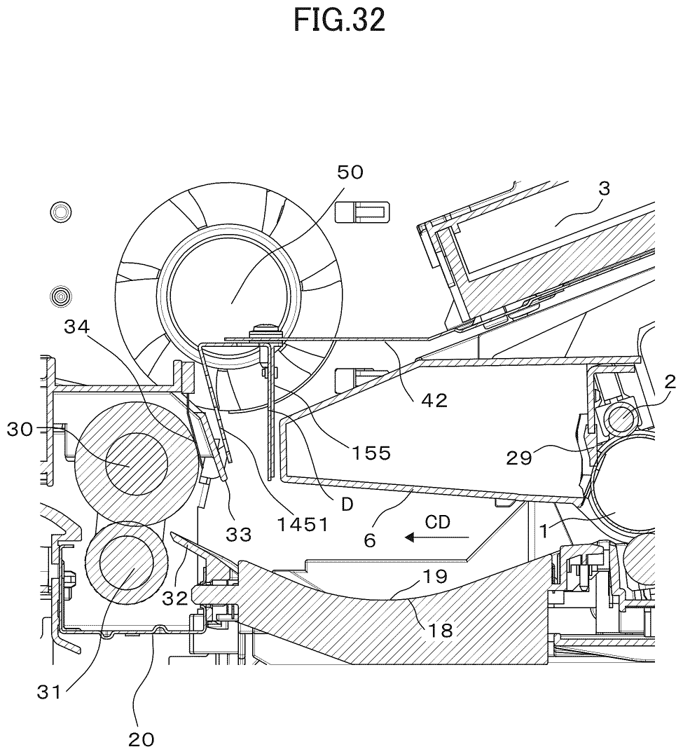

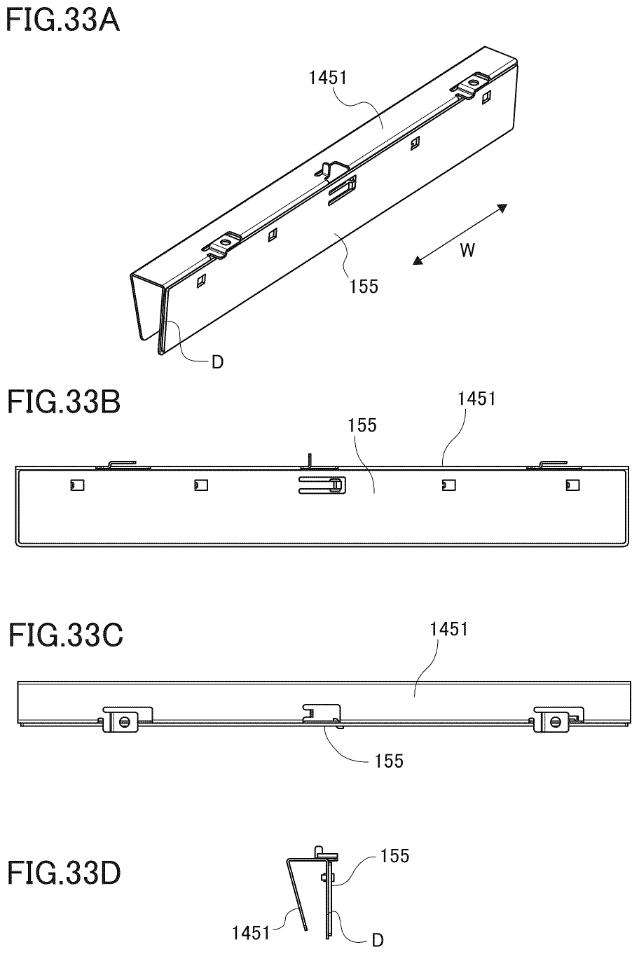

FIG. 32 is a schematic cross-sectional view of a vicinity of the heat exhaust duct 1451 according to embodiment 15. As illustrated in FIG. 32, the heat insulating member 155 is attached to the second wall portion D of the heat exhaust duct 1451 according to the present embodiment. FIG. 33A is a perspective view of the heat exhaust duct 1451 and the heat insulating member 155 according to embodiment 15, and FIG. 33B is a front view of the heat exhaust duct 1451 and the heat insulating member 155. FIG. 33C is a plan view of the heat exhaust duct 1451 and the heat insulating member 155, and FIG. 33D is a side view of the heat exhaust duct 1451 and the heat insulating member 55.

The heat insulating member 155 according to the present embodiment uses polycarbonate, which is a resin material, and it is attached to the heat exhaust duct 1451 by sliding in a thrust direction, i.e., the width direction W. In other words, the heat insulating member 155 has lower thermal conductivity than the heat exhaust duct 1451 formed of a metal material. Further, the heat exhaust duct 1451 to which the heat insulating member 155 is attached is mounted to the scanner stay 42 using a screw.

### Effects of Embodiment 15

The effects of the present embodiment will be described. By arranging the heat insulating member 155 on the second wall portion D of the heat exhaust duct 1451 as according to the present embodiment, thermal conduction from the heat exhaust duct 1451 to the cleaning unit 6 may be suppressed.

### Confirmation of Effects of Embodiment 15

Next, the results of a temperature rise experiment of the exposing unit 3 will be described to confirm the effects of the present embodiment. The heat exhaust duct 1451 according to the present embodiment and the heat exhaust duct 51 according to embodiment 1 as a comparative example have been used to confirm the effects.

The methods of the temperature rise experiment will be described in detail. A Canon Red Label (product name, Canon E.U.) having a grammage of 80 g/m2 and a sheet size of A4 was used as the recording material.

In the image forming apparatus used for the experiment, a processing speed during the experiment was 320 mm/sec, and the throughput thereof was 55 images per minute. The set temperature of the fixing device was 215° C. As for the atmospheric environment in which the experiment was performed, the temperature was 32.5° C. and the humidity was 80%.

After leaving the image forming apparatus in a power OFF state for one night and confirming that the temperature inside the apparatus is sufficiently close to the atmospheric environment, a lateral line image with an image coverage of 2% was printed by duplex continuous printing to 500 sheets, i.e., 1,000 images, and thereafter, the surface temperature of the cleaning unit 6 opposed to the heat exhaust duct 1451 was confirmed.

The result of the temperatures measured by the temperature rise experiment are shown in Table 6.

TABLE 6

| | SURFACE TEMPERATURE |
|---|---|
| | OF CLEANING UNIT |
| HEAT EXHAUST DUCT | 44° C. |
| OF EMBODIMENT 15 | |
| HEAT EXHAUST DUCT | 47° C. |
| OF EMBODIMENT 1 | |

When the heat exhaust duct 1451 according to the present embodiment was used, the surface temperature of the cleaning unit 6 was 44° C. Meanwhile, when the heat exhaust duct 51 of embodiment 1 was used, the surface temperature of the cleaning unit 6 was 47° C. That is, by adopting the heat exhaust duct 1451 according to the present embodiment, the temperature rise of the cleaning unit 6 may be suppressed.

As described, by disposing the heat insulating member 155 on the second wall portion D of the heat exhaust duct 1451 arranged adjacent to the cleaning unit 6, the rising of temperature of the cleaning unit 6 may be suppressed further. In other words, the heat shielding performance of the heat from the fixing device 20 may be enhanced.

### Embodiment 16

Next, embodiment 16 of the present invention will be described. Embodiment 16 is designed to suppress temperature rise of the cleaning unit 6 and the exposing unit 3 compared to embodiment 1. Therefore, similar configurations as embodiment 1 are either not shown or denoted with the same reference numbers.

In a case where the print speed is raised, the heat generation quantity of the fixing device 20 is increased. As a result, the heat exhaust quantity to the heat exhaust duct 51 according to embodiment 1 becomes excessive, and the influence of temperature rise of the cleaning unit 6 and the exposing unit 3 may be excessive. In that case, by disposing a heat insulating member 255 on the fixing cover side of the heat exhaust duct 51, temperature rise of the cleaning unit 6 and the exposing unit 3 may be suppressed even further.

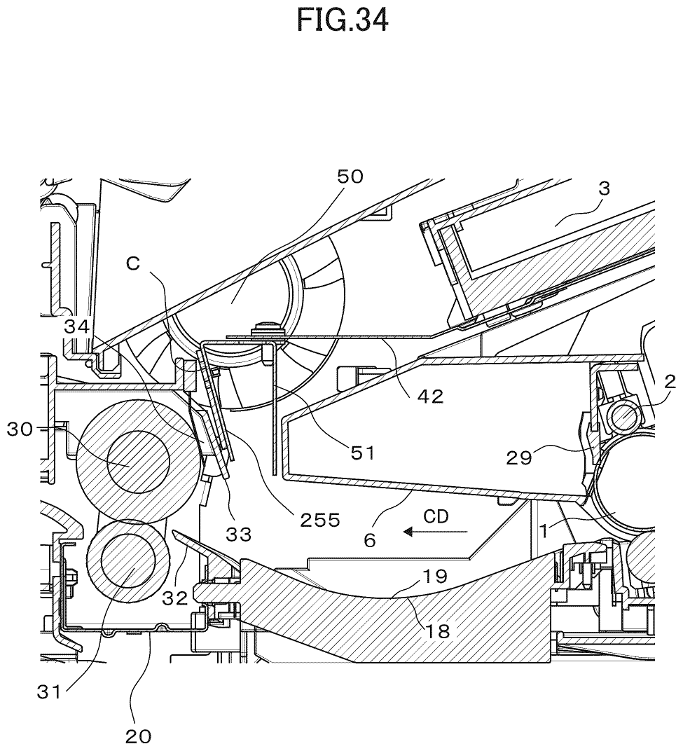

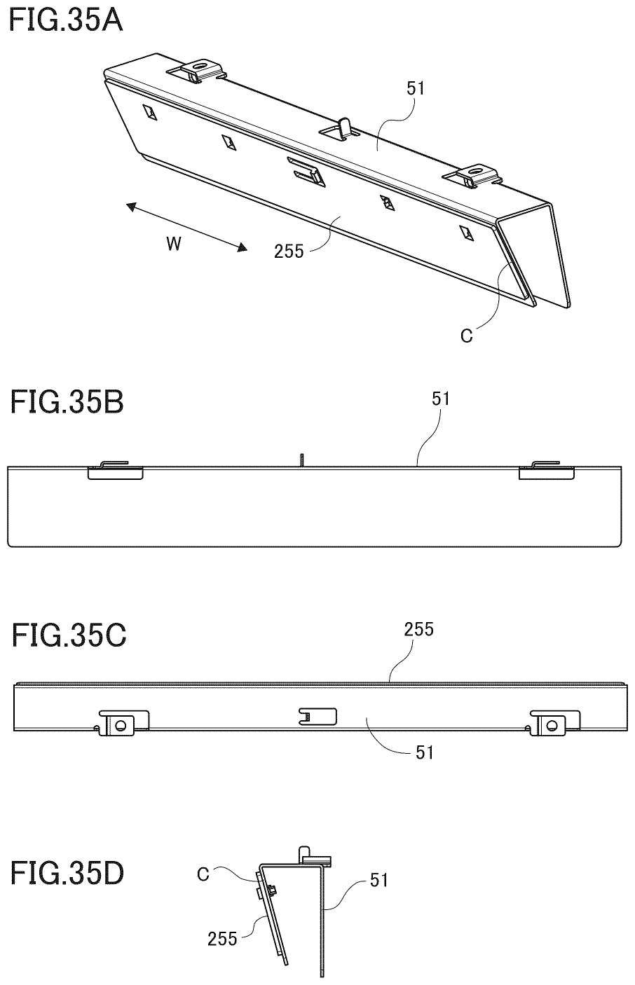

FIG. 34 is a schematic cross-sectional view of a vicinity of the heat exhaust duct 51 according to embodiment 16. As illustrated in FIG. 34, the heat insulating member 255 is attached to the first wall portion C of the heat exhaust duct 51 according to the present embodiment adjacent to the fixing device 20. FIG. 35A is a perspective view of the heat exhaust duct 51 and the heat insulating member 255 according to embodiment 16, and FIG. 35B is a front view of the heat exhaust duct 51. FIG. 35C is a plan view of the heat exhaust duct 51 and the heat insulating member 255, and FIG. 35D is a side view of the heat exhaust duct 51 and the heat insulating member 255.

The heat insulating member 255 according to the present embodiment uses polycarbonate which is a resin material having a relatively low thermal conductivity, and it is attached to the heat exhaust duct 51 by sliding in a thrust direction, i.e., the width direction W. In other words, the heat insulating member 255 has lower thermal conductivity than the heat exhaust duct 51 formed of a metal material. Further, the heat exhaust duct 51 to which the heat insulating member 255 is attached is mounted to the scanner stay 42 using a screw.

By reducing the heat exhaust quantity from the fixing device 20 to the heat exhaust duct 51, the heat exhaust itself of the fixing device 20 tends to be reduced, and the temperature rise of the cleaning unit 6 and the exposing unit 3 may be suppressed. Meanwhile, the secondary effect as described in embodiment 1 tends to be reduced, and the reached temperature of the fixing cover 33 will rise. Therefore, it may be disadvantageous from the viewpoint of performing a preferable temperature control of the heating roller 30 in a state where the reached temperatures of the fixing cover 33 are low and high, that is, the detected temperatures of the thermistor 34 are high and low.

As described above, by disposing the heat insulating member 255 on the first wall portion C of the heat exhaust duct 51 close to the fixing cover 33, the heat exhaust of the fixing device 20 through the heat exhaust duct 51 may be reduced, and the temperature rise of the cleaning unit 6 and the exposing unit 3 may be suppressed. In other words, the heat shielding performance of heat from the fixing device 20 may be enhanced.

In embodiment 15, the heat insulating member 155 is attached to the second wall portion D, whereas in embodiment 16, the heat insulating member 255 is attached to the first wall portion C. It may also be possible to attach the heat insulating members 155 and 255 to the first wall portion C and the second wall portion D. That is, the heat insulating member having a lower thermal conductivity than the heat exhaust duct is to be disposed on at least either one of the first wall portion C and the second wall portion D of heat exhaust duct.

### Embodiment 17

Next, embodiment 17 of the present invention will be described. Embodiment 17 has changed the shape of the heat exhaust duct 951 of embodiment 10. Therefore, similar configurations as embodiment 10 are either not shown or denoted with the same reference numbers.

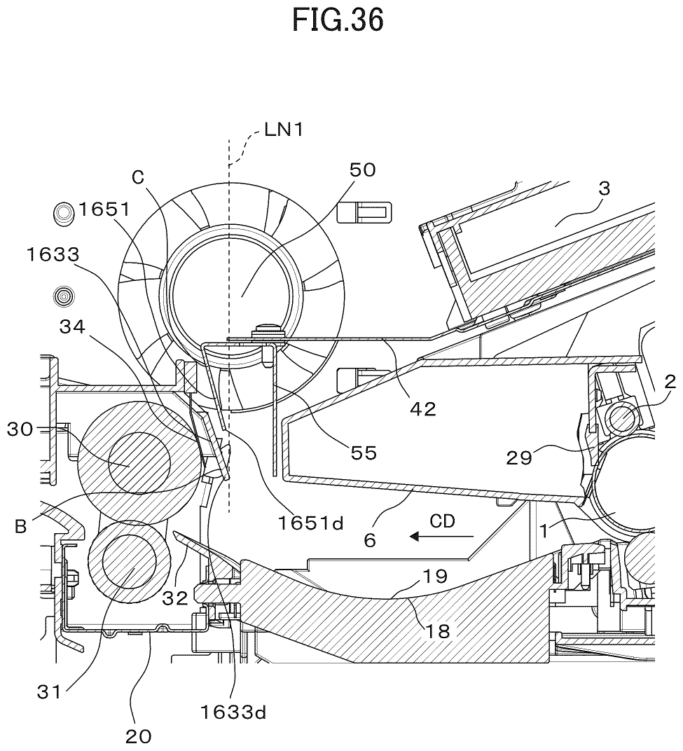

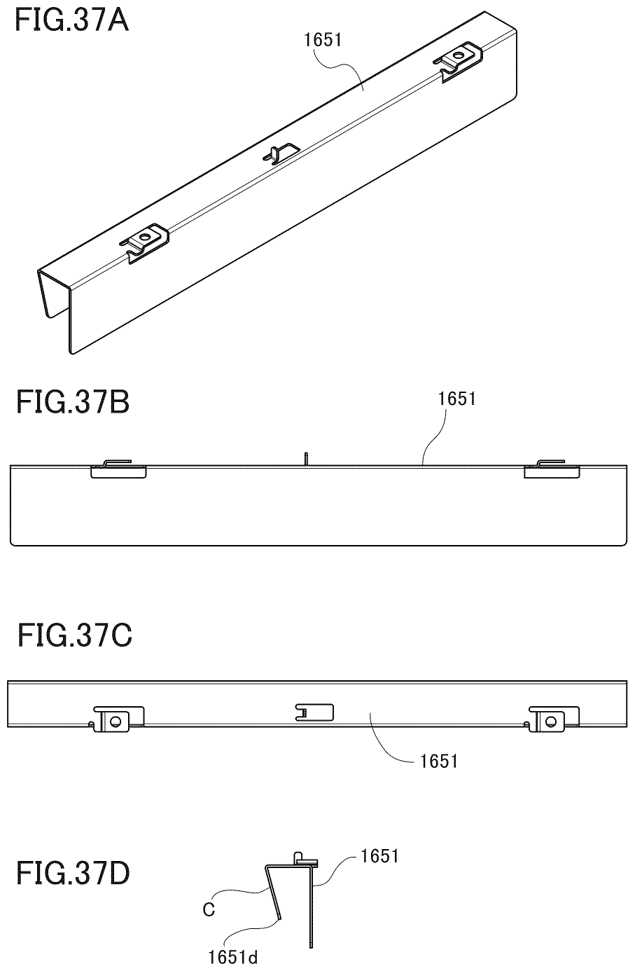

FIG. 36 is a schematic cross-sectional view of a vicinity of a heat exhaust duct 1651 according to embodiment 17. FIG. 37A is a perspective view of the heat exhaust duct 1651 according to embodiment 17, and FIG. 37B is a front view of the heat exhaust duct 1651. FIG. 37C is a plan view of the heat exhaust duct 1651, and FIG. 37D is a side view of the heat exhaust duct 1651.

The heat exhaust duct 1651 serving as a duct of the preset embodiment is formed to have a shorter length of the first wall portion C close to the fixing device 20 with respect to the shape of the heat exhaust duct 51 of embodiment 1. A fixing cover 1633 is formed of a resin material having superior electric insulation property, such as a polycarbonate. Therefore, the present embodiment achieves a stable conveyance performance without causing defects such as wrinkling of paper, without being affected by the electrostatic attraction force that acts on the heat exhaust duct 1651 from the recording material P, similar to embodiment 10.

That is, according to the present embodiment, as illustrated in FIG. 36, the first wall portion C of the heat exhaust duct 1651 adjacent to the planar portion B of the fixing cover 1633 is arranged so as not to cross over the straight line LN1 that passes an end portion 1633d of the planar portion B and that extends in the vertical direction. That is, an end portion 1651d of the first wall portion C is arranged downstream of the straight line LN1 in the conveyance direction CD. In other words, the planar portion B is arranged to cover the end portion 1651d of the first wall portion C of the heat exhaust duct 1651. Therefore, effects similar to embodiments 10 and 11 may be exerted.

### Embodiment 18

Next, embodiment 18 of the present invention will be described. Embodiment 18 has changed the shape of the heat exhaust duct 1151 of embodiment 12. Therefore, similar configurations as embodiment 12 are either not shown or denoted with the same reference numbers.

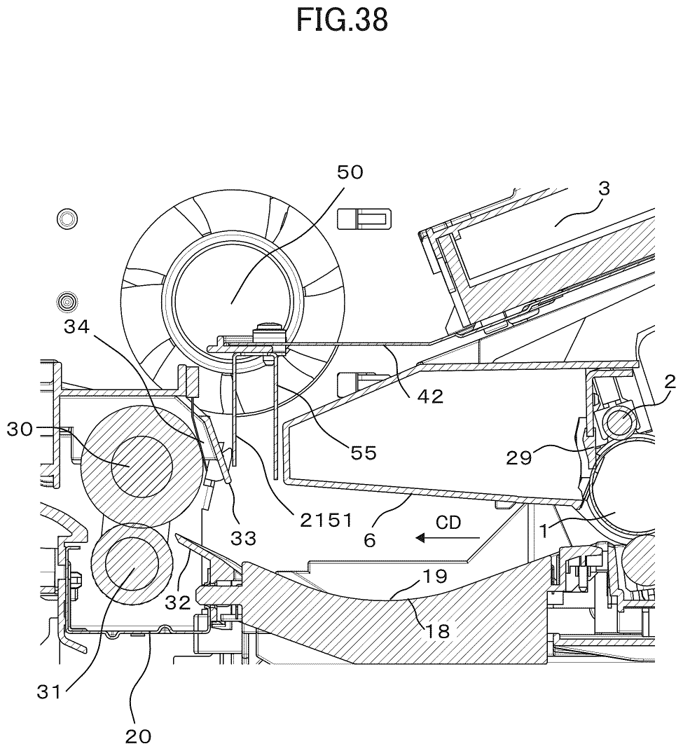

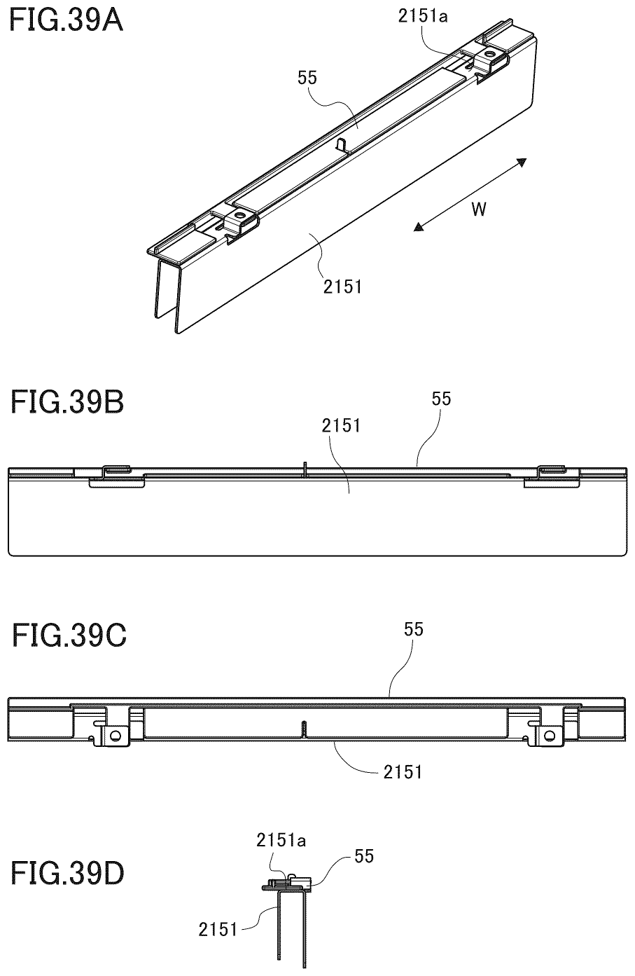

FIG. 38 is a schematic cross-sectional view of a vicinity of the heat exhaust duct 2151. FIG. 39A is a perspective view of the heat exhaust duct 2151 and the heat insulating member 55 according to embodiment 18, and FIG. 39B is a front view of the heat exhaust duct 2151. FIG. 39C is a plan view of the heat exhaust duct 2151 and the heat insulating member 55, and FIG. 39D is a side view of the heat exhaust duct 2151 and the heat insulating member 55. As illustrated in FIGS. 38 to 39D, the heat exhaust duct 2151 according to the present embodiment adopts a similar shape as the heat exhaust duct of comparative example 1 illustrated in FIGS. 8A to 8D. In addition, the heat insulating member 55 similar to embodiment 12 is assembled to the upper surface 2151a of the heat exhaust duct 2151.

The heat exhaust duct 2151 is attached to the scanner stay 42 in a state where the heat insulating member 55 is interposed between the heat exhaust duct 2151 and the scanner stay 42. Thereby, the thermal conduction from the heat exhaust duct 2151 to the scanner stay 42 may be suppressed, and temperature rise of the exposing unit 3 may be suppressed. That is, effects similar to embodiment 12 may be exerted. It may also be possible to attach the heat insulating member 55 to the upper surface of the heat exhaust duct 2251 of comparative example 2 illustrated in FIGS. 9A to 9D.

### Embodiment 19

Next, embodiment 19 of the present invention will be described. Embodiment 19 has changed the shape of the heat exhaust duct 1451 of embodiment 15. Therefore, similar configurations as embodiment 15 are either not shown or denoted with the same reference numbers.

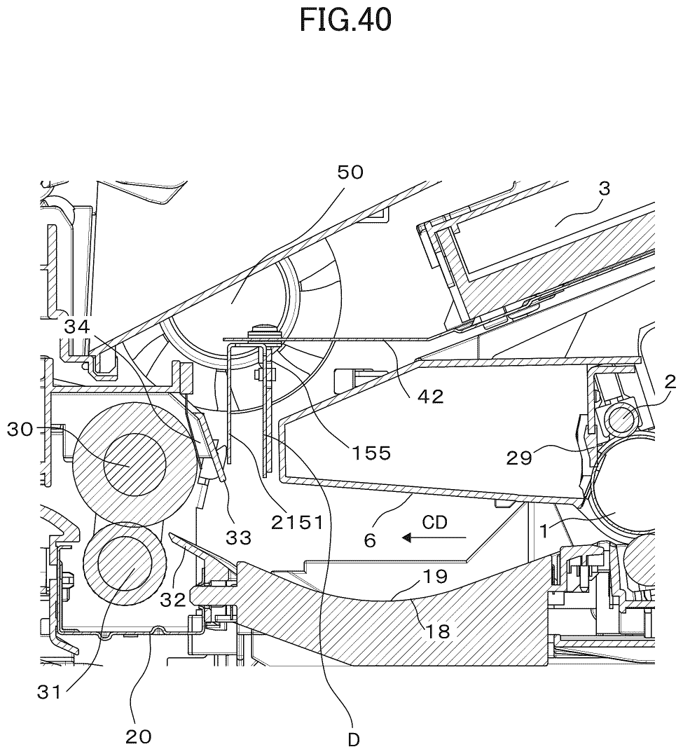

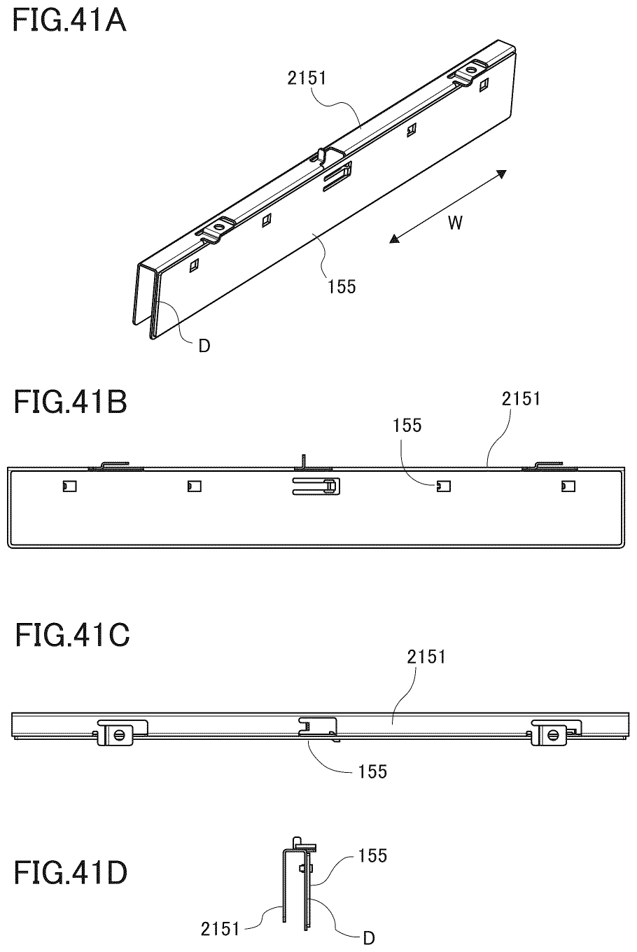

FIG. 40 is a schematic cross-sectional view of a vicinity of the heat exhaust duct 2151 according to embodiment 19. FIG. 41A is a perspective view of the heat exhaust duct 2151 and the heat insulating member 155 according to embodiment 19, and FIG. 41B is a front view of the heat exhaust duct 2151 and the heat insulating member 155. FIG. 41C is a plan view of the heat exhaust duct 2151 and the heat insulating member 155, and FIG. 41D is a side view of the heat exhaust duct 2151 and the heat insulating member 155.

As illustrated in FIGS. 40 to 41D, the heat exhaust duct 2151 according to the present embodiment has a similar shape as the heat exhaust duct of comparative example 1 illustrated in FIGS. 8A to 8D. The heat insulating member 155 similar to embodiment 15 is assembled to the second wall portion D close to the cleaning unit 6 of the heat exhaust duct 2151. Thereby, thermal conduction from the heat exhaust duct 2151 to the cleaning unit 6 may be suppressed, and temperature rise of the cleaning unit 6 may be suppressed, similar to embodiment 15. It may also be possible to attach the heat insulating member 155 to the second wall portion D of the heat exhaust duct 2251 of comparative example 2 illustrated in FIGS. 9A to 9D.

### Embodiment 20

Next, embodiment 20 of the present invention will be described. Embodiment 20 has changed the shape of the heat exhaust duct 51 of embodiment 16. Therefore, similar configurations as embodiment 16 are either not shown or denoted with the same reference numbers.

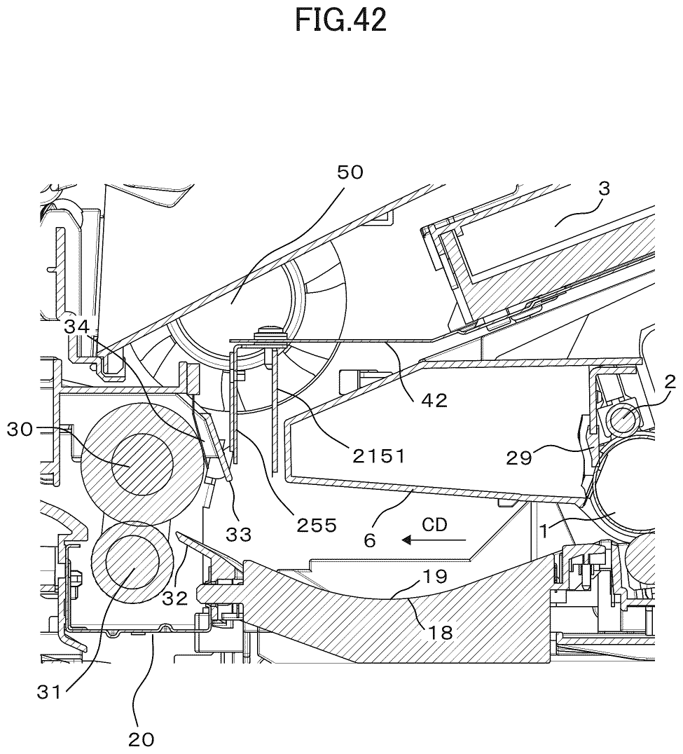

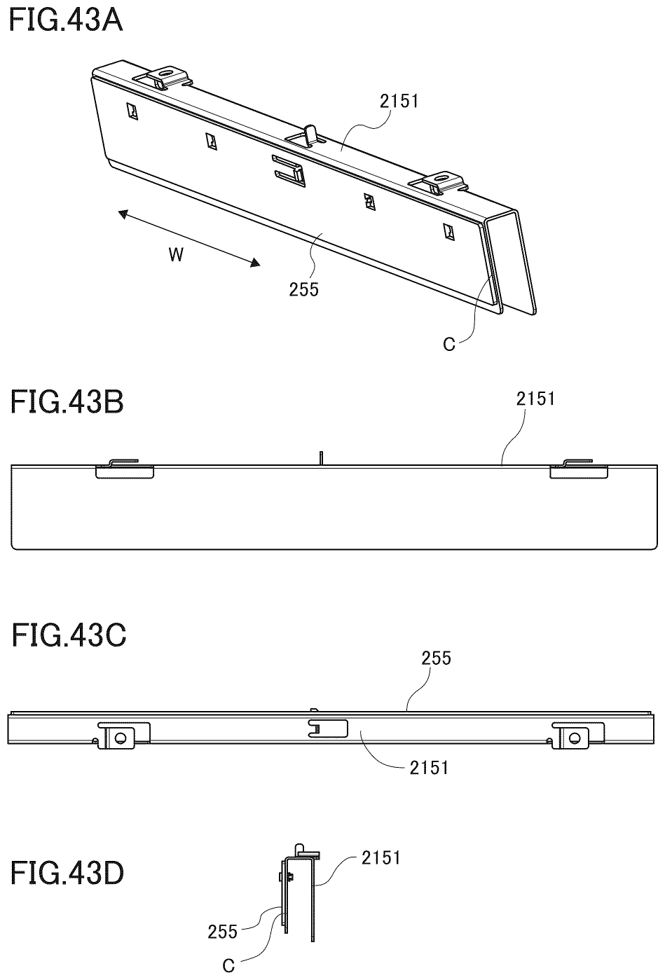

FIG. 42 is a schematic cross-sectional view of a vicinity of the heat exhaust duct 2151 according to embodiment 20. FIG. 43A is a perspective view of the heat exhaust duct 2151 and the heat insulating member 255 according to embodiment 20, and FIG. 43B is a front view of the heat exhaust duct 2151. FIG. 43C is a plan view of the heat exhaust duct 2151 and the heat insulating member 255, and FIG. 43D is a side view of the heat exhaust duct 2151 and the heat insulating member 255.

As illustrated in FIGS. 42 to 43D, the heat exhaust duct 2151 according to the present embodiment has a similar shape as the heat exhaust duct of comparative example 1 illustrated in FIGS. 8A to 8D. The heat insulating member 255 similar to embodiment 16 is assembled to the first wall portion C close to the fixing device 20 of the heat exhaust duct 2151.

By assembling the heat insulating member 255 to the first wall portion C of the heat exhaust duct 2151, the heat exhaust quantity from the fixing device 20 to the heat exhaust duct 2151 may be reduced. Thereby, temperature rise of the cleaning unit 6 and the exposing unit 3 may be suppressed, similar to embodiment 16. It may also be possible to attach the heat insulating member 255 to the first wall portion C of the heat exhaust duct 2251 of comparative example 2 illustrated in FIGS. 9A to 9D.

### OTHER EMBODIMENTS

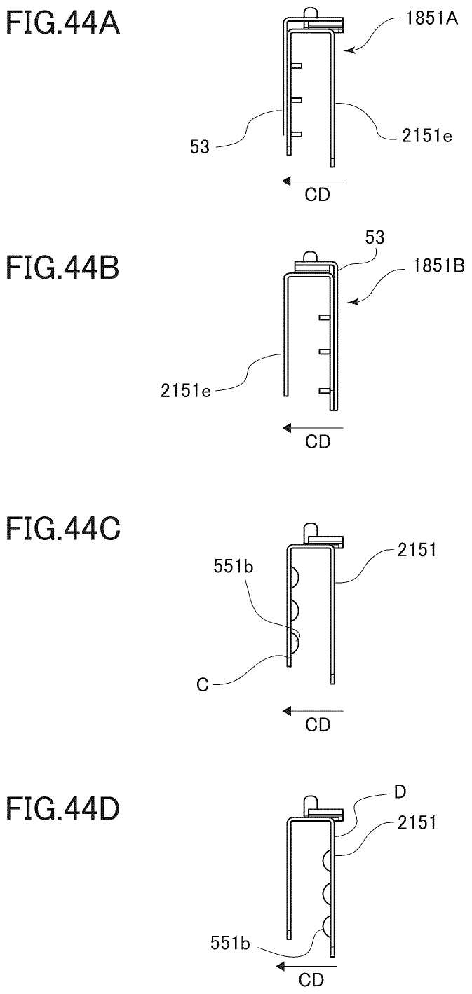

In embodiment 3, the heat exhaust fin 53 is attached from the downstream side in the conveyance direction CD to the main body portion 651e having a shape approximately similar to embodiment 1, but the present technique is not limited thereto. For example, as according to the modified example 1 illustrated in FIG. 44A, the heat exhaust fin 53 may be attached from the downstream side in the conveyance direction CD to a main body portion 2151e having a similar shape as comparative example 1 illustrated in FIGS. 8A to 8D. A heat exhaust duct 1851A serving as a duct is composed of the main body portion 2151e and the heat exhaust fin 53. Even in this case, effects similar to embodiment 3 may be exerted. Further, the heat exhaust fin 53 may be attached from the downstream side in the conveyance direction CD to the heat exhaust duct 2251 of comparative example 2 illustrated in FIGS. 9A to 9D.

The heat exhaust fin 53 may also be attached from the upstream side in the conveyance direction CD to the main body portion 2151e having a similar shape as comparative example 1 illustrated in FIGS. 8A to 8D, as according to the modified example 2 illustrated in FIG. 44B. A heat exhaust duct 1851B serving as a duct is composed of the main body portion 2151e and the heat exhaust fin 53. Even in this case, effects similar to embodiment 3 may be exerted. Further, the heat exhaust fin 53 may be attached from the upstream side in the conveyance direction CD to the heat exhaust duct 2251 of comparative example 2 illustrated in FIGS. 9A to 9D.

Further, in embodiment 6, the projected portion 551b having a similar function as the heat exhaust fin 53 is disposed on the heat exhaust duct 551 having a similar shape as embodiment 1, but the present technique is not limited thereto. For example, the projected portion 551b may be disposed on the first wall portion C close to the fixing device 20 of the heat exhaust duct 2151 having a similar shape as comparative example 1 illustrated in FIGS. 8A to 8D, as according to modified example 3 illustrated in FIG. 44C. Even according to this case, effects similar to embodiment 6 may be exerted. Further, the projected portion 551b may be disposed on the first wall portion C of the heat exhaust duct 2251 according to comparative example 2 illustrated in FIGS. 9A to 9D.

Further, as illustrated in modified example 4 illustrated in FIG. 44D, the projected portion 551b may be disposed on the second wall portion D close to the cleaning unit 6 of the heat exhaust duct 2151 having a shape similar to comparative example 1 illustrated in FIGS. 8A to 8D. Even according to this case, effects similar to embodiment 6 may be exerted. Further, the projected portion 551b may be disposed on the second wall portion D of the heat exhaust duct 2251 according to comparative example 2 illustrated in FIGS. 9A to 9D.

According to any of the embodiments and comparative examples described above, the fixing device 20 was equipped with the heating roller 30 including a heat source, but the present technique is not limited thereto. For example, various heaters such as a ceramic heater or a halogen heater may be adopted as the heat source of the heating roller 30. Alternatively, a fixing film formed in a film shape may be adopted instead of the heating roller 30. The fixing film is heated by various heaters such as the ceramic heater or the halogen heater. Alternatively, a fixing belt having a heat generation layer may be adopted instead of the heating roller 30, wherein the heat generation layer is heated by electromagnetic induction heating.

All the embodiments, modified examples, and comparative examples described above may also be combined arbitrarily.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-203372, filed Nov. 30, 2023, which is hereby incorporated by reference herein in its entirety.

What is claimed is:

1. An image forming apparatus configured to form a toner image on a sheet, the image forming apparatus comprising:
an image bearing member configured to rotate;
a developing member configured to form a toner image on the image bearing member by supplying toner to the image bearing member;
a transfer member configured to transfer the toner image formed on the image bearing member onto a sheet;
a cleaning member configured to abut against a surface of the image bearing member and remove toner from the surface of the image bearing member;
a toner collecting container configured to collect the toner removed from the surface of the image bearing member by the cleaning member;
a fixing unit configured to fix the toner image transferred onto the sheet by the transfer member to the sheet; and
a duct disposed between the toner collecting container and the fixing unit, the duct forming an air passage through which air flowing toward an exterior of the image forming apparatus flows,
wherein the duct includes a first wall portion opposed to the fixing unit and a second wall portion opposed to the toner collecting container, and
wherein the first wall portion is inclined with respect to the second wall portion.

2. The image forming apparatus according to claim 1, wherein the first wall portion is inclined with respect to the second wall portion such that a distance between the second wall portion and a first end portion of the first wall portion closest to a conveyance path through which a sheet passes between the transfer member and the fixing unit is shorter than a distance between the second wall portion and a second end portion of the first wall portion farthest from the conveyance path.

3. The image forming apparatus according to claim 1, wherein the first wall portion is formed linearly when viewed in a rotational axis direction of the image bearing member.

4. The image forming apparatus according to claim 1, wherein the first wall portion is formed to be curved when viewed in a rotational axis direction of the image bearing member.

5. The image forming apparatus according to claim 1, wherein the second wall portion extends in a vertical direction.

6. The image forming apparatus according to claim 1, wherein the fixing unit includes a fixing member configured to heat the toner image on the sheet, and a fixing cover configured to cover the fixing member, and
wherein the fixing cover includes an opposing surface that is opposed to the first wall portion and that extends along the first wall portion.

7. The image forming apparatus according to claim 1, further comprising a fan that is arranged on one side of the duct in a rotational axis direction of the image bearing member and that is configured to blow air,
wherein the duct is arranged to be overlapped with the fan when viewed in the rotational axis direction.

8. The image forming apparatus according to claim 1, wherein the second wall portion of the duct extends to a position closer to a conveyance path through which a sheet passes between the transfer member and the fixing unit than the cleaning member when viewed in a rotational axis direction of the image bearing member.

9. The image forming apparatus according to claim 1, wherein the duct is arranged on a same side as the toner collecting container with respect to a conveyance path through which a sheet passes between the transfer member and the fixing unit.
